(19) United States
(12) Patent Application Publication
(10) Pub. No.: US 2012/0116809 A1
(43) Pub. Date: May 10, 2012

(54) METHOD FOR CREATING AND/OR KEEPING A PERSONAL MEDICATION FILE WITH THE AID OF A COMPUTER SYSTEM

(75) Inventor: Cornelis Wilhelmus Henricus Schaap, Heilige Landstichting (NL)

(73) Assignee: Consumer Health Entrepreneurs B.V., Nijmegen (NL)

(21) Appl. No.: 13/290,505

(22) Filed: Nov. 7, 2011

(30) Foreign Application Priority Data
Nov. 8, 2010 (NL) 2005649
Jun. 15, 2011 (NL) 2006940

(51) Int. Cl. G06Q 50/24

(52) U.S. Cl. 705/3

(57) ABSTRACT

Method for creating and/or keeping a personal medication file with the aid of a computer system, comprising:

a. utilizing a first database of the computer system in which by a patient information on the use of his personal medication, coupled to information on the identity of the patient, is stored, characterized in that the method further comprises:

b utilizing a second database of the computer system in which standard information of known medications is stored, while in step a. the patient utilizes information from the second database for filling the first database.

The invention relates to a method for creating and/or keeping a personal medication file with the aid of a computer system, comprising:

a. utilizing a first database of the computer system, wherein by a patient information on the use of his personal medication, coupled to information on the identity of the patient, is stored in the first database.

Such a method is known from inter alia WO 01/55949. In the known method a patient enters the medications he uses at the first database with the aid of a computer system. Because the patient generally does not have any medical training, the computer system also sends a request to a medical expert, such as a physician or a pharmacist, to check the information entered. This can be carried out, for example, by sending the expert by e-mail a hyperlink that is linked with the information entered by the patient about his use of his personal medication. The expert can then download via the computer system the information entered by the patient about the use of his personal medication, whereupon the computer system, for example, displays this information on a screen to the medical expert. The medical expert can then check whether the information shown is correct. If the medical expert establishes that the information concerned is correct, he will indicate this in the first database in a validation field intended for this purpose. From this field, accordingly, it appears that the information concerned has been checked by a medical expert and has been entered correctly by the patient.

A disadvantage of the known method is that the method does not provide a possibility of adequately correcting information on the use of a medication that has been entered incorrectly by the patient, for example by a collaboration or consultation between the medical expert and the patient. Even if the medical expert could contact the patient, for example because the information has not been entered unambiguously, this still would not afford a possibility of correcting the information definitively. If a patient were to correct the information after, for example, a message from a medical expert, it is still not certain that the information concerned has been entered correctly.

The object of the invention is to solve or prevent a number of problems of the known methods. The method according to the invention is accordingly characterized in that the method further comprises:

b. utilizing a second database of the computer system in which standard information of known medications is stored, wherein in step a. the patient utilizes information from the second database for filling the first database.
As the patient, when entering information on the use of his personal medication, also utilizes information that is stored in the second database, it can be accomplished that the information that the user stores in the first database is correct and unambiguous. For the sake of completeness, it is noted that information on use of personal medications also covers information on the use of personal medications from the past and which medications are presently not used anymore (history).

In particular, it holds here that in step a. information on the use of a medication is stored in the first database by the patient according to standard information from the second database on the medication to be entered. More particularly, it holds here that in the entering of the information on the use of the medication by the patient, the computer system, on the basis of a keyword entered by the patient at the computer system, generates a list of possible medications and shows it to the patient, whereupon the patient selects from the list a medication that corresponds to the medication that he uses, whereupon the selected information on the medication, coupled to the identity of the patient, is stored in the first database in the form of standard information. In this manner, it is accomplished that correct and unambiguous information on the use of medications is entered by the patient.

In particular, it holds here that the patient, of a medication used, also enters information on the frequency of taking a medicine according to the medication, the form of administration of the medicine, the strength of the medicine, the use of the medicine (for example, the period of taking the medicine), the origin of the medicine (supplier), the brand of the medicine, information on a storage life of the medicine, and/or an identity of a person such as a physician or pharmacist, care institution, pharmacy and/or hospital that has prescribed the medication. ‘Medication’ is here understood to mean a prescribed medicine together with a desired manner of administration of the medicine such as a frequency of taking it, a manner of taking it, a period of taking it, etc.

According to a highly advanced embodiment of the method, it holds that the computer system generates an alert for the patient when after the entering of new information on a medication used in step a. it appears from the first database that the new information does not go together with information from the first database on the use of a medication that the patient already uses.

In the foregoing the assumption has been that the patient already has access to his information in the first database. The initiative towards storing information of the patient in the first database and providing the patient access to the first database may lie, for example, with a first entity. Preferably, it holds then that the first database in a step c. is initially filled with information of the patient by a first entity such as a physician and/or pharmacy and/or pharmacist and/or hospital and/or care institution, after which the first entity provides the patient access to his information in the first database. Also, it is possible that the patient first shows the initiative to store information about the patient in the first database. In that case, the first database in an initial step c. is first filled by the patient. The initial filling of the database by the first entity and/or the patient with information of the patient may also comprise only the filling of the database with information on the identity of the patient. Information on the use of medicines and/or other information on the patient can then be entered subsequently, coupled to the identity of the patient, at the first database by the first entity and/or the patient. Access provision by the first entity to the patient can be done when the patient has indicated that he is interested in this. If the patient is not interested, the first entity can use the first database himself and no access to the first database is provided to the patient. In particular, the first database in a step d. is filled by the first entity with information on the identity of the patient. Next, in a step e., by the first entity and/or by the patient, information on the use of the personal medication, coupled to information on the identity of the patient, can be stored in the first database. Also, in the step e., other information on the patient may be stored which is coupled to the identity of the patient. This other information can comprise, for example, results of tests that have been performed on the patient, for example by the first entity, such as X-rays, MRI scans, CT scans and lab results. If the first entity has provided the patient access to the first database, from that moment the patient can inspect his information in the first database. When the patient himself has no access to the first database, the patient can inspect the first database when he is present at the first entity. Then the first entity can inspect the database together with the patient, and in consultation with the patient supplement and/or modify the information of the patient in the first database. When, for example, the patient indicates he is using or no longer using certain medicines, the first database can be modified accordingly.

In particular, in step e. the first entity utilizes the standard information from the second database for filling the first database. Preferably, here, in step e. information on the use of a medication is stored in the first database by the patient according to standard information from the second database on the medication to be entered.

The patient may, if desired, decide to provide access to his information in the first database to a second entity such as a physician and/or pharmacy and/or pharmacist and/or hospital and/or care institution.

Here, preferably, the second identity is granted access not to the complete first database but only to that part of the first database that contains information on the patient concerned. In particular, after providing the second entity access to the first database, information on the patient from the first database may be sent by e-mail or similar message to the second entity and/or the second entity is granted an opportunity to obtain or consult information of the patient from the first database, for example, by downloading, printing, or reading from a display. Preferably, the second entity is provided access to information of the patient that is stored in the first database only when the patient has provided access to the second entity, while, in particular, the patient also indicates which information the patient provides the second entity access to. The patient can provide the second entity access, for example, for an indefinite period of time, provide access for a definite period of time, or'provide once-only access to information of the patient stored in the first database. In exceptional circumstances, the second entity may obtain access to information of the patient in the first database anyway, even if the second entity has not obtained permission from the patient for this. Such a special circumstance may occur, for example, when the patient is in danger of life and is incapable of providing access to the second entity. In that case, however, it is preferred that the fact that the second entity has consulted information on the patient in the first database be stored in, for example, the first database, so that it can be verified later that the second entity has not taken advantage of the access obtained. Also, the patient may withdraw the access he has provided to the second entity. Thus the patient is and remains the lord and master of the information stored about him in the first database.

Preferably, it holds that the second database is filled with information on medicines according to the G-standard. The patient in step a. then uses this standardized information for filling the first database with information on his use of medicines (medications).

An object of the system and the method according to the invention is therefore to accomplish that every care provider (one of the entities mentioned) from the patient's network has the same information available 24/7/365; only with permission of the patient, of course. That permission can mean authorization at different levels and can be changed by the patient continuously. All is logged with inspection for the patient.

For the patient the advantages are that as few misunderstandings as possible will arise about the treatment, as well as the possibilities of reviewing his own use, of targeted search for information, and of targeted communication about this (e.g., with a preferred care provider).

In a particular embodiment of the system and the method according to the invention, this can proceed as follows:

In the personal medication file of patient A an appointment is planned with care institution B (one of the entities mentioned). That appointment comes about in that the medication file of patient A, that is, the particular embodiment of the system according to the invention that comprises the first database, upon instruction from patient A, has asked the planning system of care institution B or someone from care institution B (from the list of care institutions patient A is dealing with) for an appointment. To this end, accordingly, the system according to the invention is communicatively connected with the planning system of the care institution B. The planning system of the care institution or someone from the care institution himself sends a date/time back to the personal medication file of patient A. Upon receipt by patient A, via the system according to the invention, of the date/time proposal of care institution B, patient A accepts the appointment, via the system according to the invention, at the planning system of the care institution B or at someone of care institution B, and the appointment is in the personal medication file of patient A. If patient A accepts this at his personal medication file, his personal medication file sends the planned appointment, in confirmation, back to care institution B and in particular on to Google Calendar or Outlook of patient A. However, the appointment may also come about at the request of care institution B in that care institution B has asked the personal medication file of patient A if patient A will come and visit the care institution. Patient A then starts the cycle as above.

In particular, for the appointment (set/default) the personal medication file of patient A automatically sends a request for information to the system of care institution B. Along with that request, a once-only permission may be sent for care institution B to retrieve at other care institutions (other entities) information on patient A via the “National Switch Point”. Depending on the permission, the system of care institution B can send the available, or collected, information to the personal medication file of patient A. The personal medication file receives the information and, preferably, automatically matches that received information with the information from the “current” overview of patient A in the first database. Any discrepancies result in a question to patient A which is generated by the system comprising the first database and is stored in the personal medication file of patient A. Patient A solves that question or not. If “not”, the question ends up in the overview of points-to-discuss of patient A in his personal medication file. During the visit to care institution B, patient A can go through these points with the care provider B. For example, furthermore, the then-existing overview is approved by patient A and, as a definitive overview for once-only use by care institution B, is sent to the system of care institution B as well as added to the personal medication file of patient A. The visit/the treatment can begin.

In particular, care institution B, after the treatment or at the end of the visit, creates an electronic prescription with treatment plan for patient A and sends that prescription and treatment plan via the system according to the invention to the personal medication file of patient A. In particular, after that, patient A can select a pharmacy C to which the prescription is sent (patient A cannot modify the prescription). With the prescription, preferably, a current medication overview comes along, and possibly a once-only permission to retrieve information at other care providers (entities). The prescription, after being sent to pharmacy C, is added in the personal medication file of patient A to the list of “proposed medicines of patient A” and the prescription itself is deleted from the personal medication file of patient A after transmission to pharmacy C. Pharmacy C delivers/sends the medicines to patient A and preferably a message of delivery to the personal medication file of patient A. Patient A, after receipt of the medicines, starts the use thereof physically and fills in the actual use in his personal medication file, with the status of the medicine changing to “current” with an actual use.

On the retrieval of other information at other care institutions as discussed above, the following may be noted. In principle, pharmacy C cannot find any differences if care institution B has already done a search also. However, supposing that patient A in the meantime has started using chemist's medicines or internet medicines, a discrepancy can occur between what patient A and care institution B have approved and pharmacy C finds. That is why, preferably, pharmacy C sends an overview of the medicines used to the personal medication file of patient A. The system according to the invention then preferably compares this received information with the current information such as it is stored in the personal medication file of patient A and, in case of variance, generates a question at patient A, and/or the care institution B and/or the pharmacy C.

Further, the following applies:

1. Wherever it says “patient A”, anyone authorized and having the proper level of authorization may undertake the actions of patient A.

2. Wherever it says “automatically”, the action may also be triggered manually.

3. Wherever in respect of any action “sending” or “automatically processing” presupposes implicit automatisms, this may also be carried out manually at existing interfaces.

4. All is logged in the personal medication file and can be consulted.

5. If there are no interfaces (possible), the interface is replaced by paper with the possibility of transfer/retyping errors and extra work.

6. Place for indication/diagnosis in the personal medication file (part of medical information of the patient)

Around this, all kinds of services can be developed in the field of communication between patient A and/or care institution B and/or pharmacy C and/or other entities such as reminder services, skype contacts, and the like.

The invention will presently be elucidated in more detail with reference to the drawings.

In the drawings:

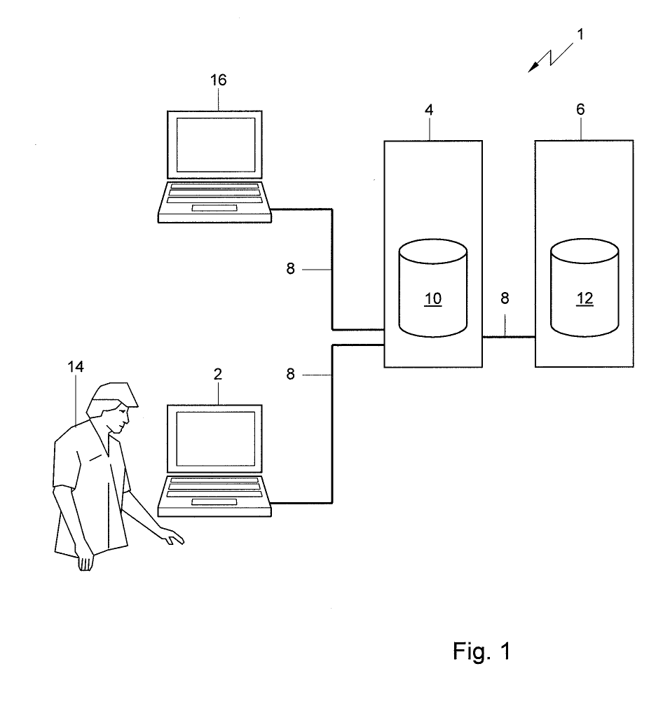

FIG. 1 shows a computer system according to the invention for carrying out a method according to the invention;

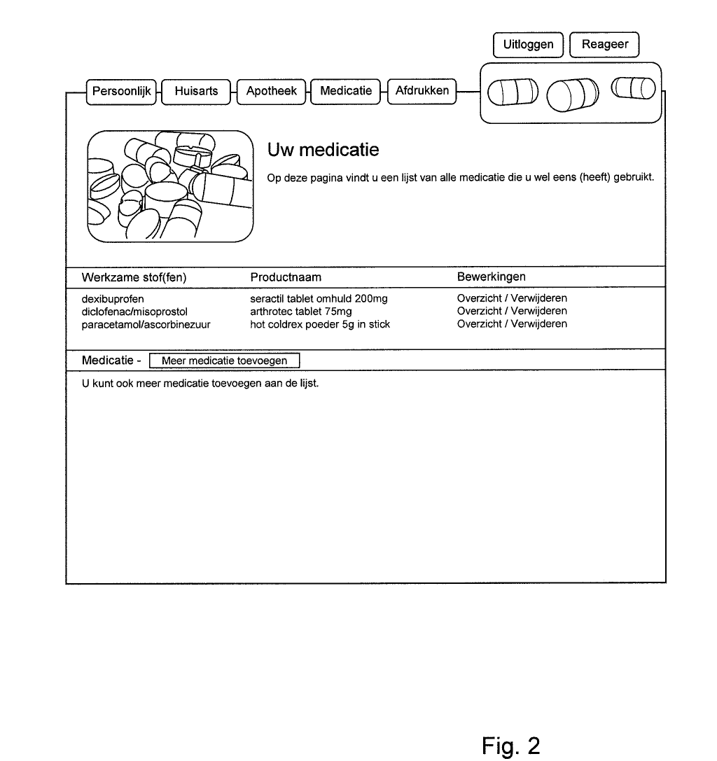

FIG. 2 shows a first fill-in screen for carrying out a step a. of a possible method according to the invention;

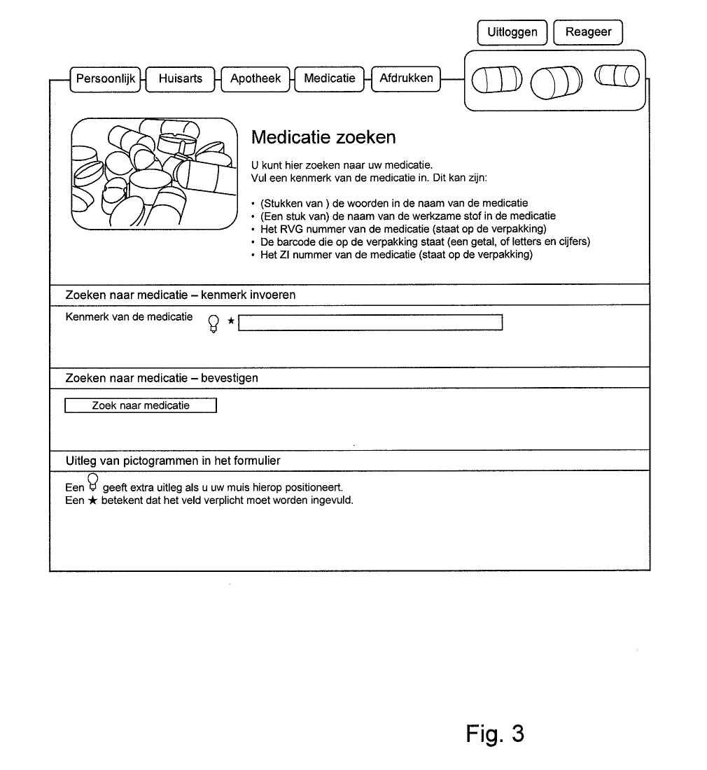

FIG. 3 shows a second fill-in screen for carrying out a step a. of a possible embodiment of the method;

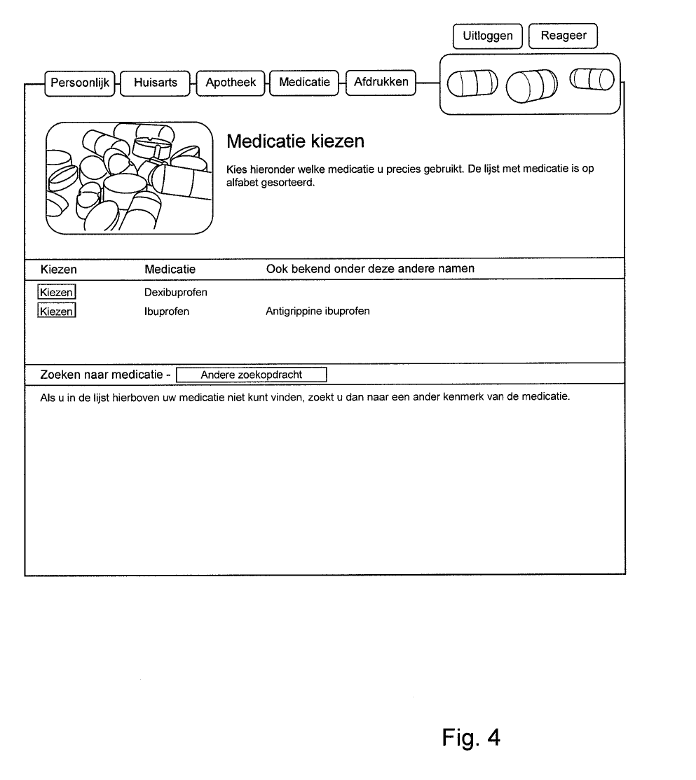

FIG. 4 shows a third fill-in screen for carrying out step a. of a possible embodiment of the method;

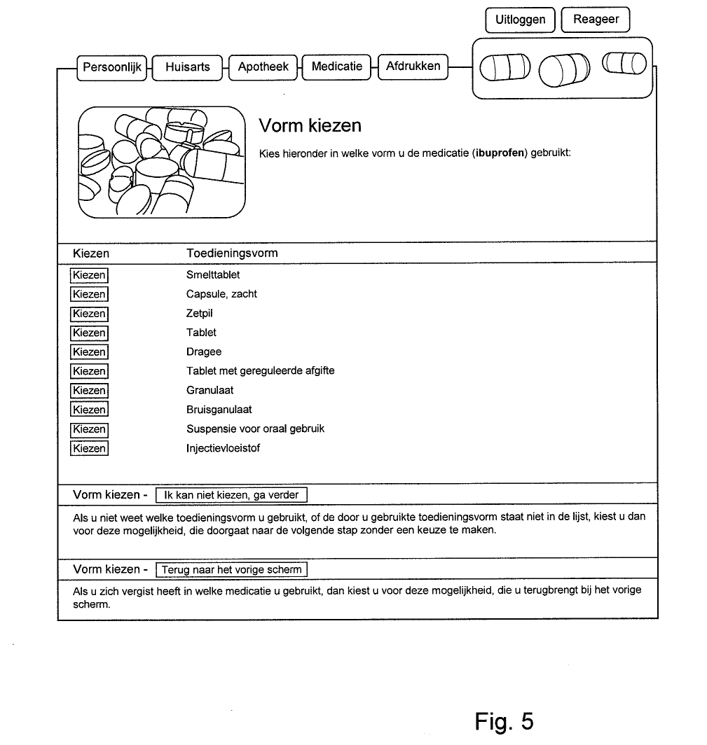

FIG. 5 shows a fourth fill-in screen for carrying out a step a. of a possible method according to the invention;

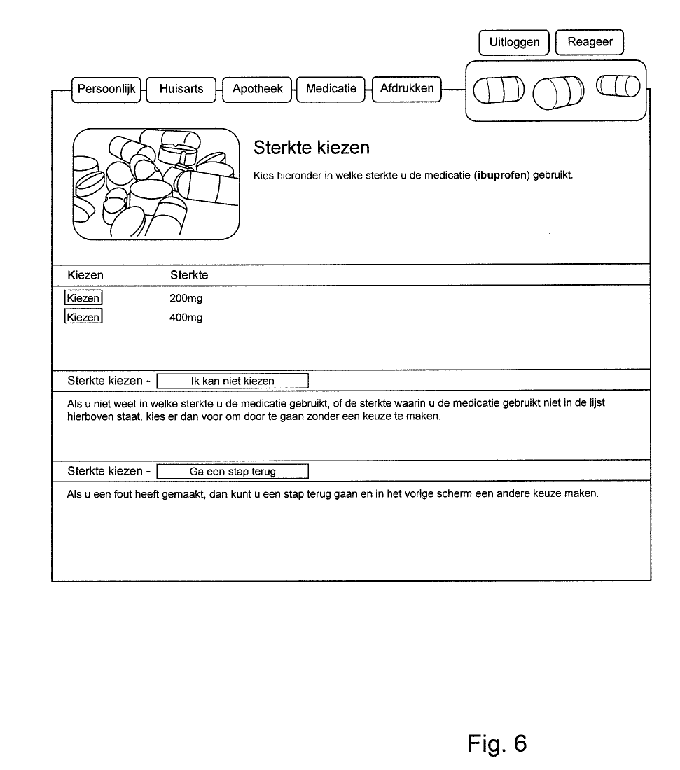

FIG. 6 shows a fifth fill-in screen for carrying out step a. of a possible embodiment of the method;

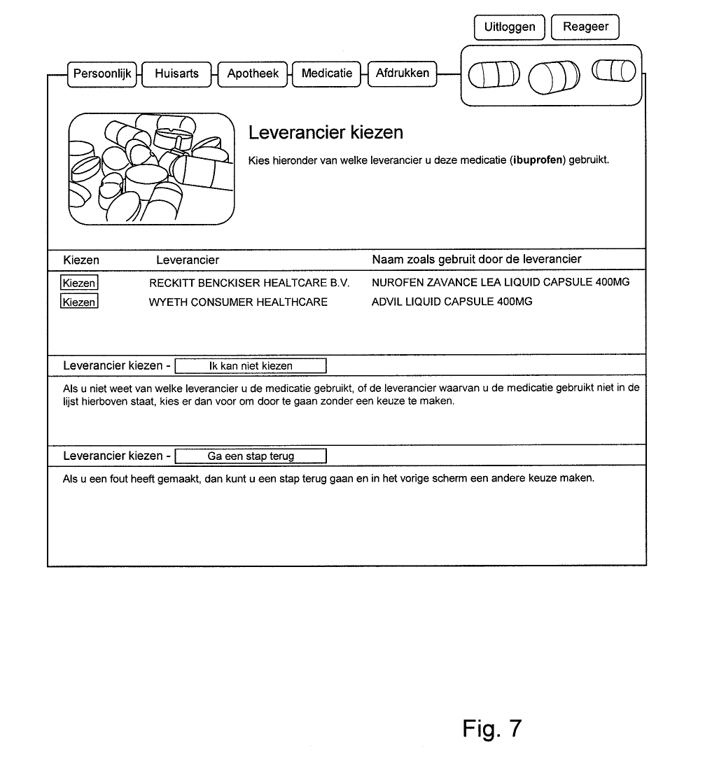

FIG. 7 shows a sixth fill-in screen for carrying out step a. of a possible embodiment of the method;

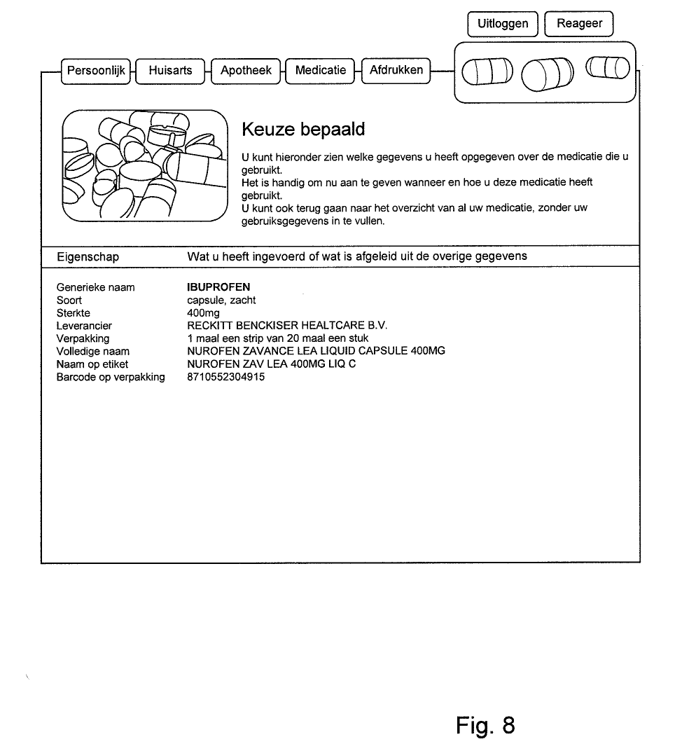

FIG. 8 shows a screen with information on the use of a particular medication entered by a patient;

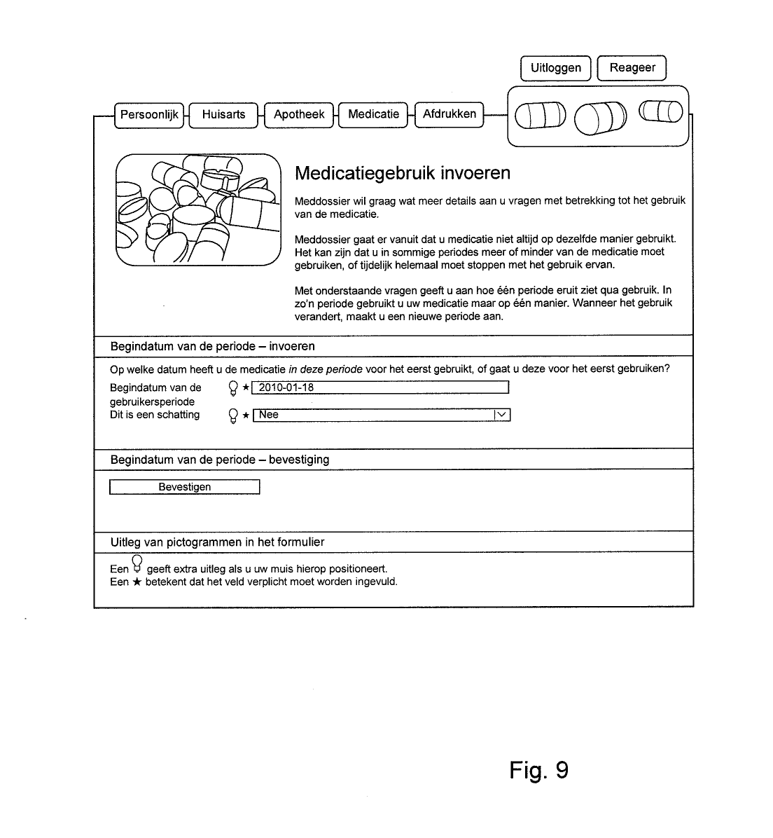

FIG. 9 shows a seventh fill-in screen for carrying out step a. of a possible embodiment of the method;

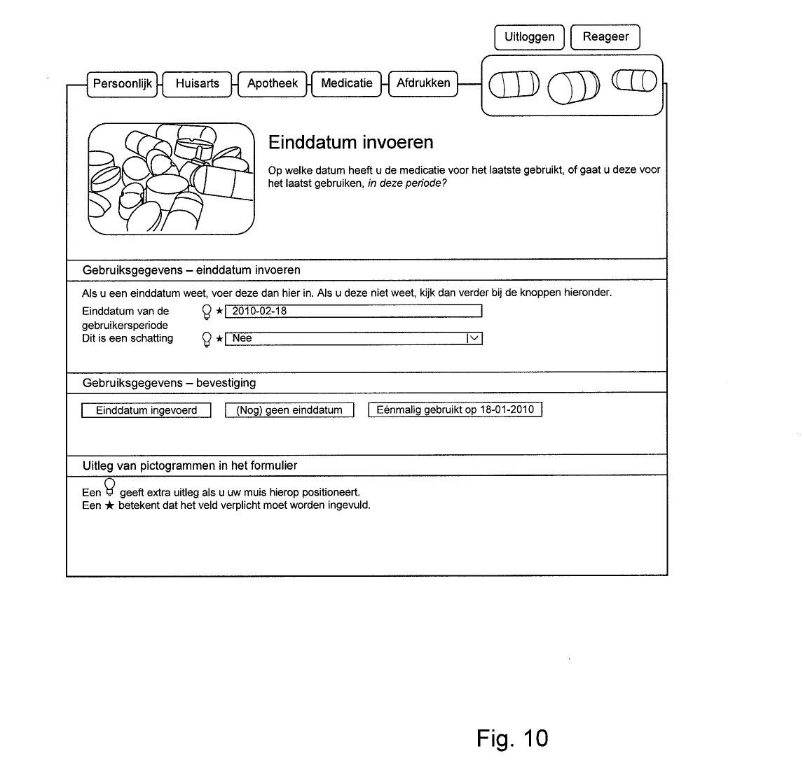

FIG. 10 shows an eighth fill-in screen for carrying out step a. of a possible embodiment of the method;

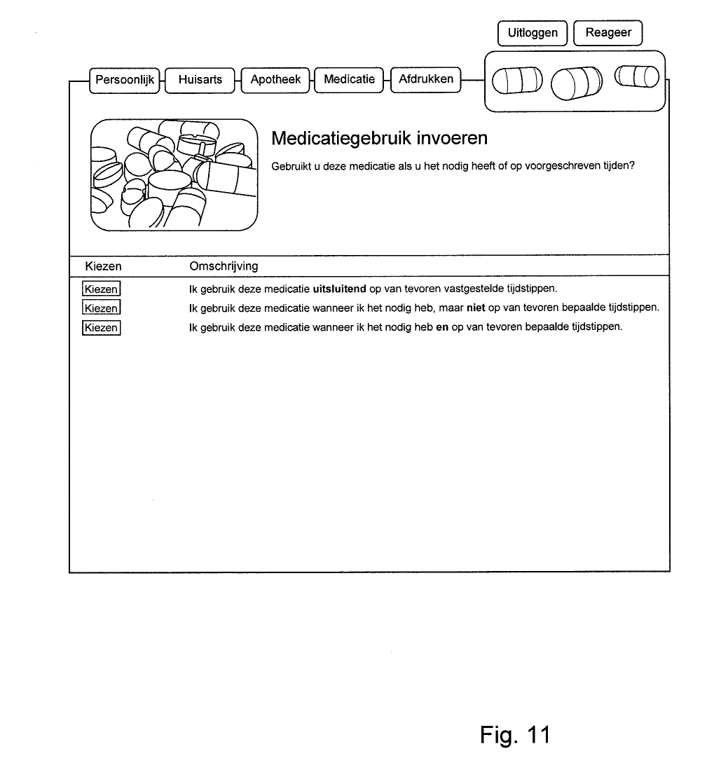

FIG. 11 shows a ninth fill-in screen for carrying out a step a. of a possible method according to the invention;

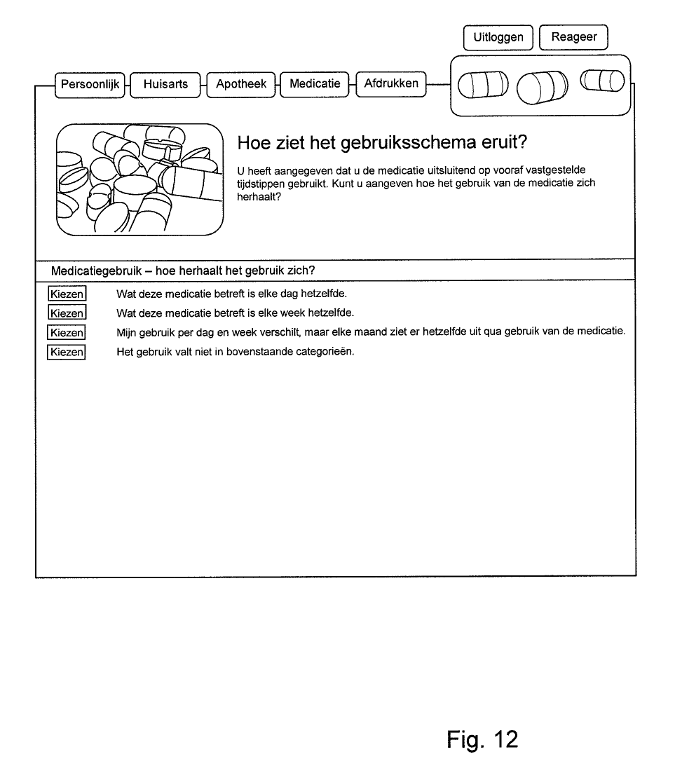

FIG. 12 shows a tenth fill-in screen for carrying out step a. of a possible embodiment of the method;

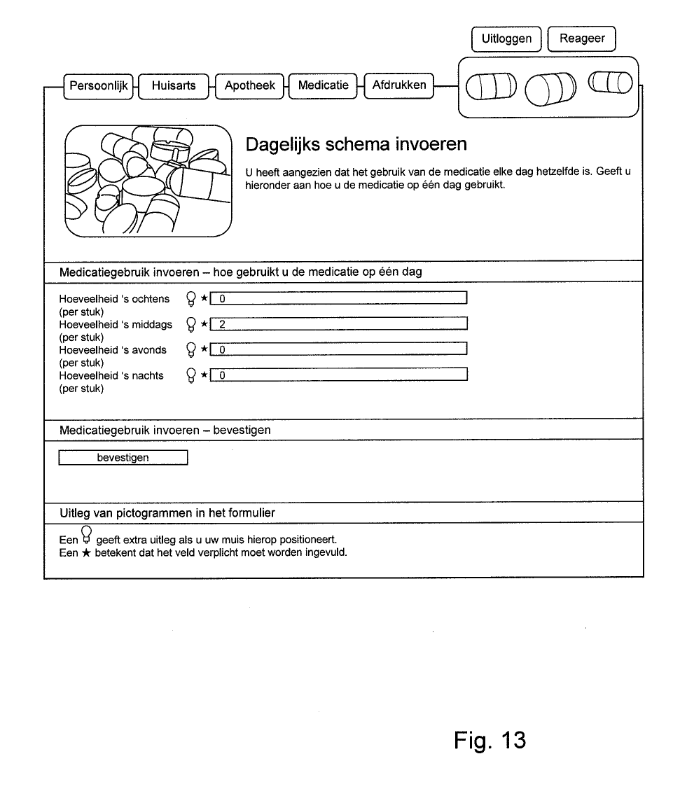

FIG. 13 shows an eleventh fill-in screen for carrying out step a. of a possible embodiment of the method;

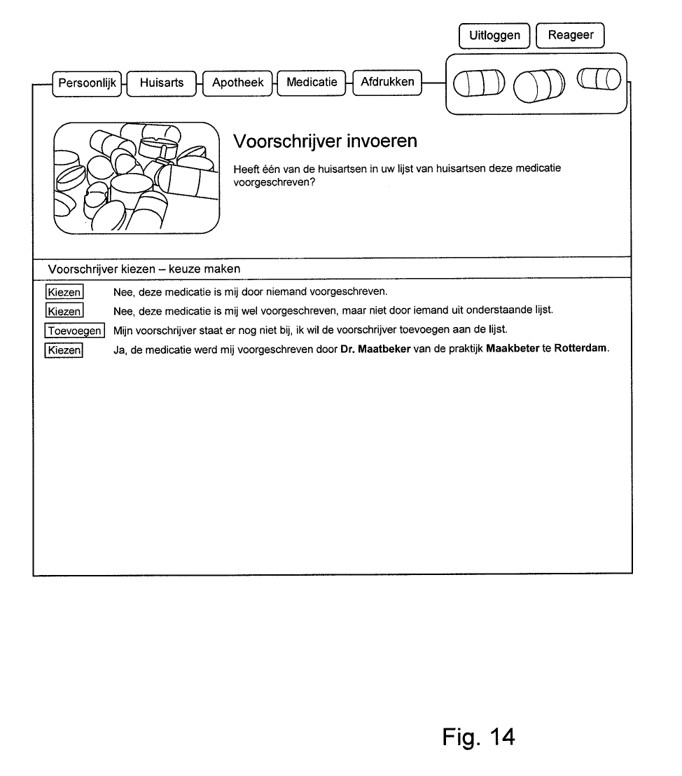

FIG. 14 shows a twelfth fill-in screen for carrying out step a. of a possible method according to the invention;

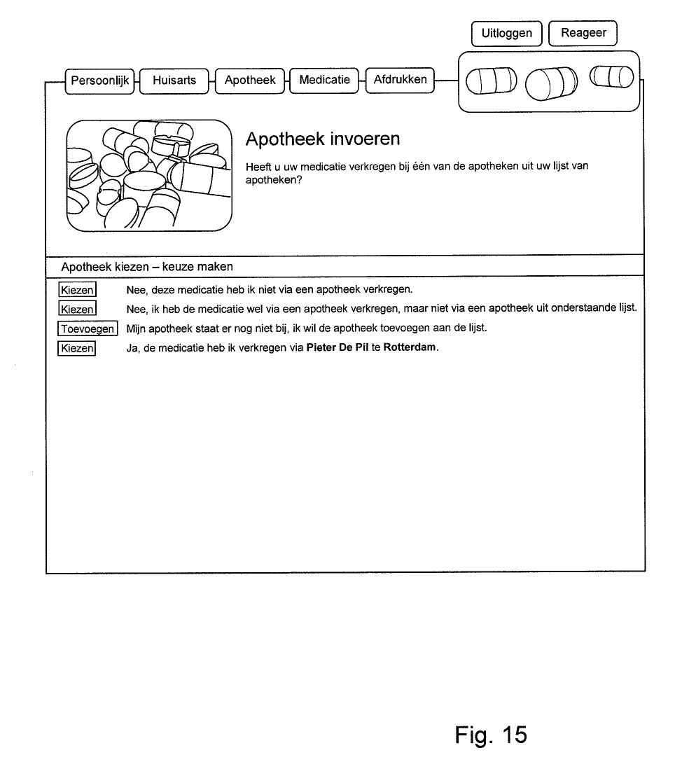

FIG. 15 shows a thirteenth fill-in screen for carrying out step a. of a possible embodiment of the method;

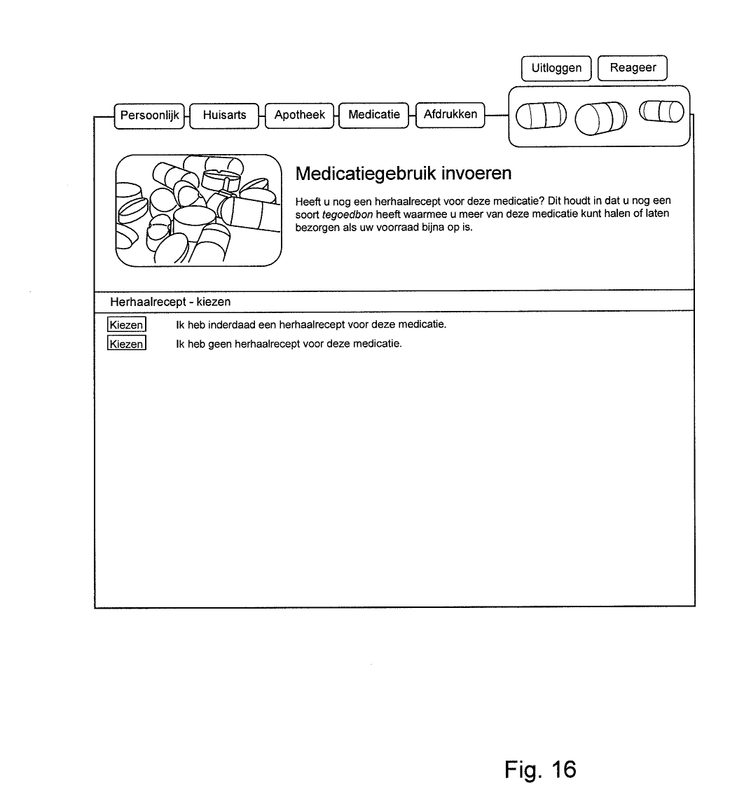

FIG. 16 shows a fourteenth fill-in screen for carrying out step a. of a possible embodiment of the method;

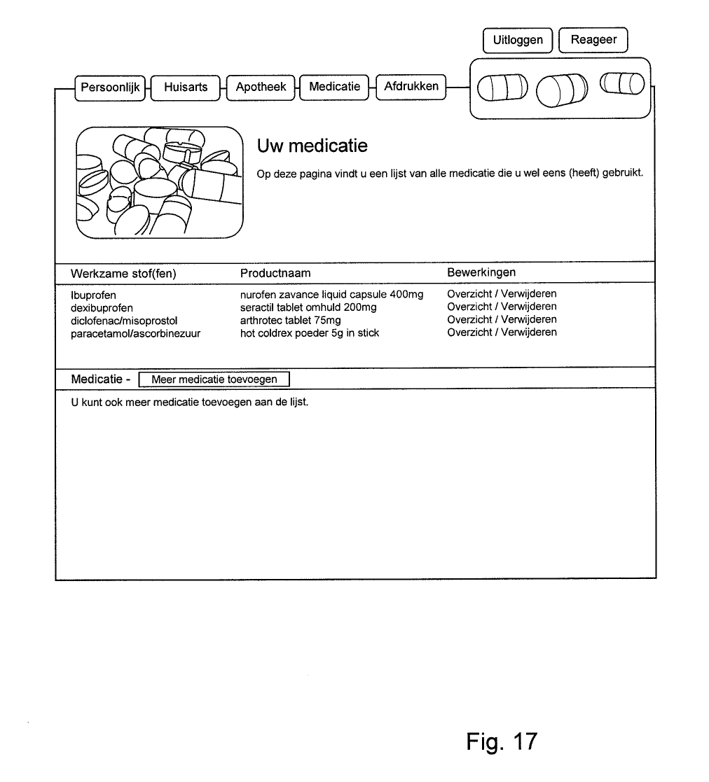

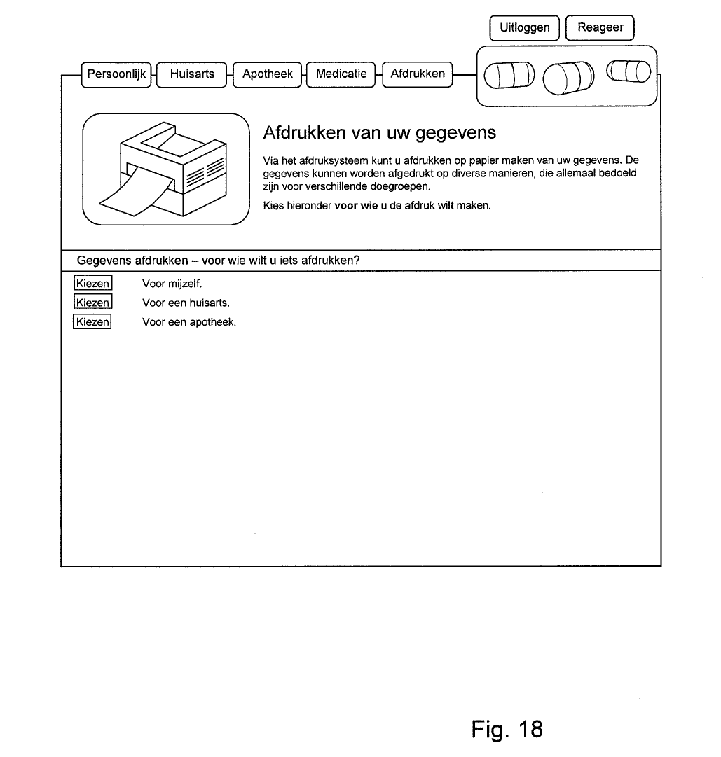

FIG. 17 shows an upgraded screen overview, also fill-in screen for new medication;

FIG. 18 shows a fill-in screen for printing information;

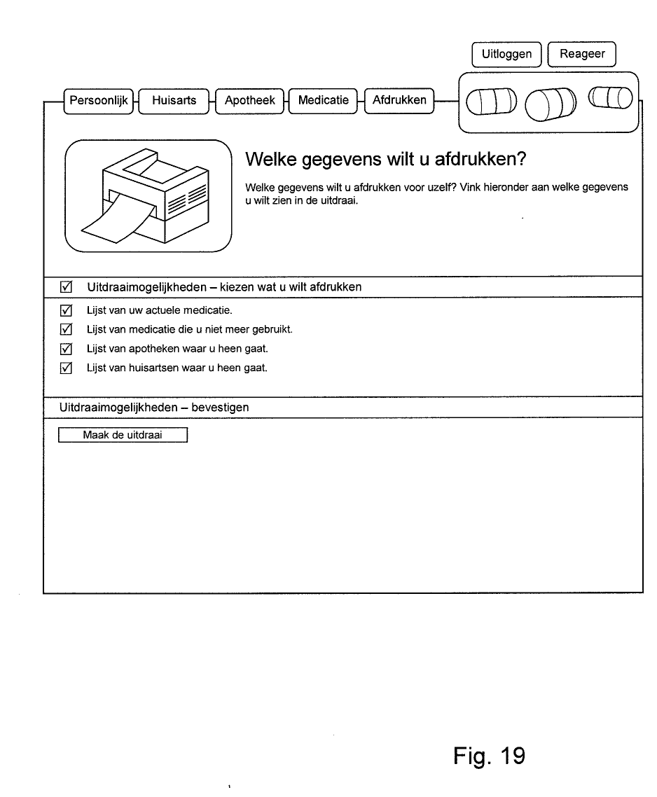

FIG. 19 shows a fill-in screen for printing information;

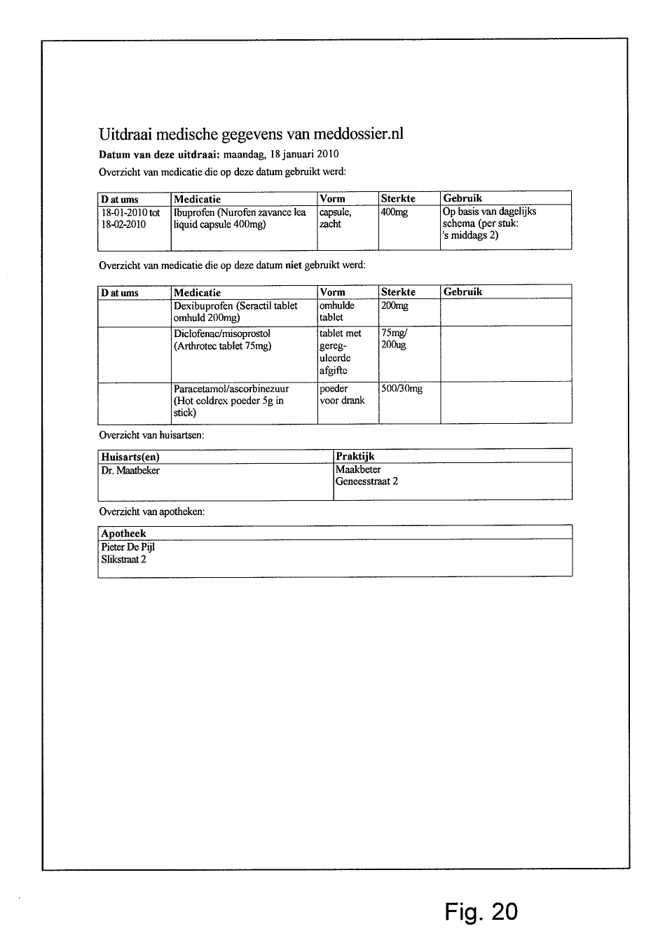

FIG. 20 shows a possible printout by a patient on the use of his medications;

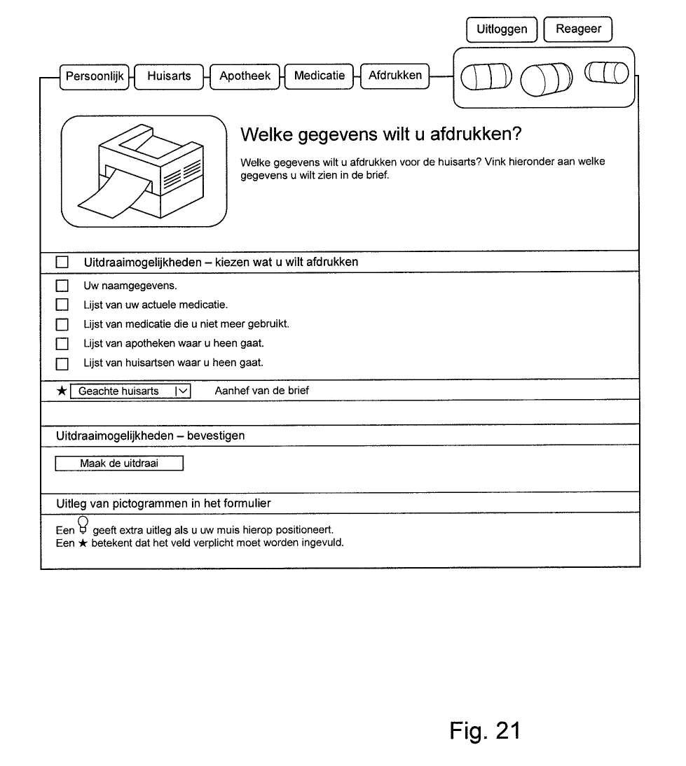

FIG. 21 shows a fill-in screen for printing information;

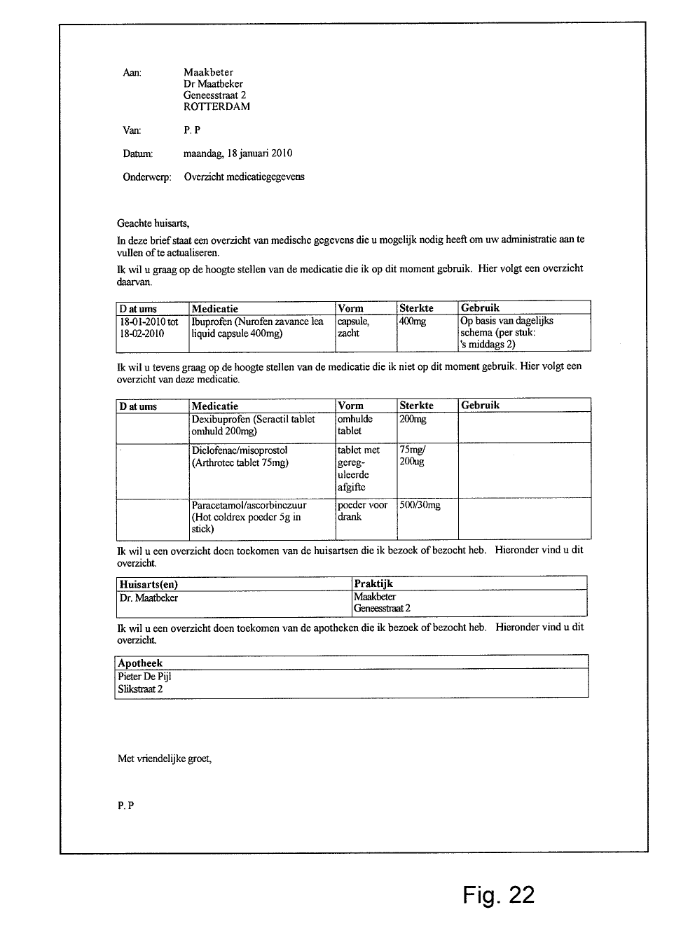

FIG. 22 shows a possible letter to a general practitioner generated with the computer system, based on information from the first database;

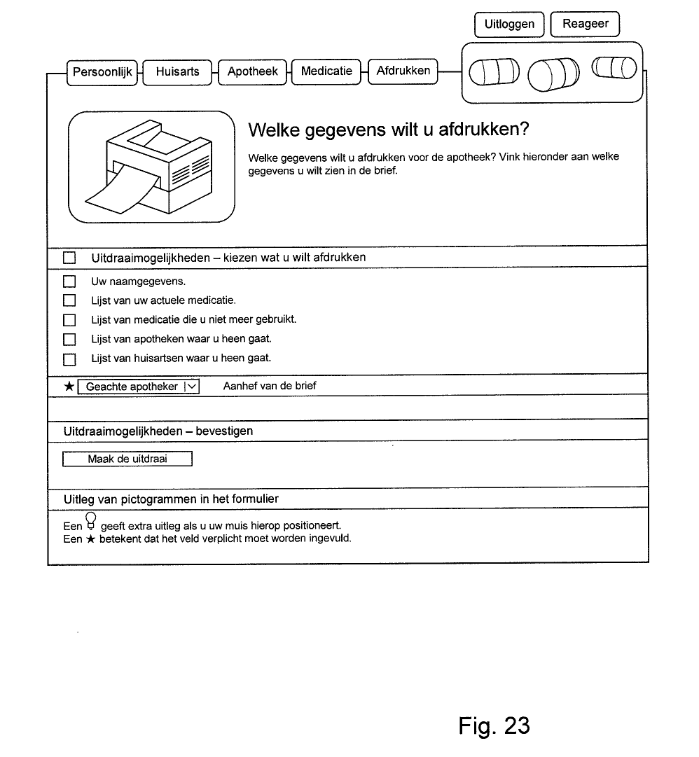

FIG. 23 shows a fill-in screen for printing information; and

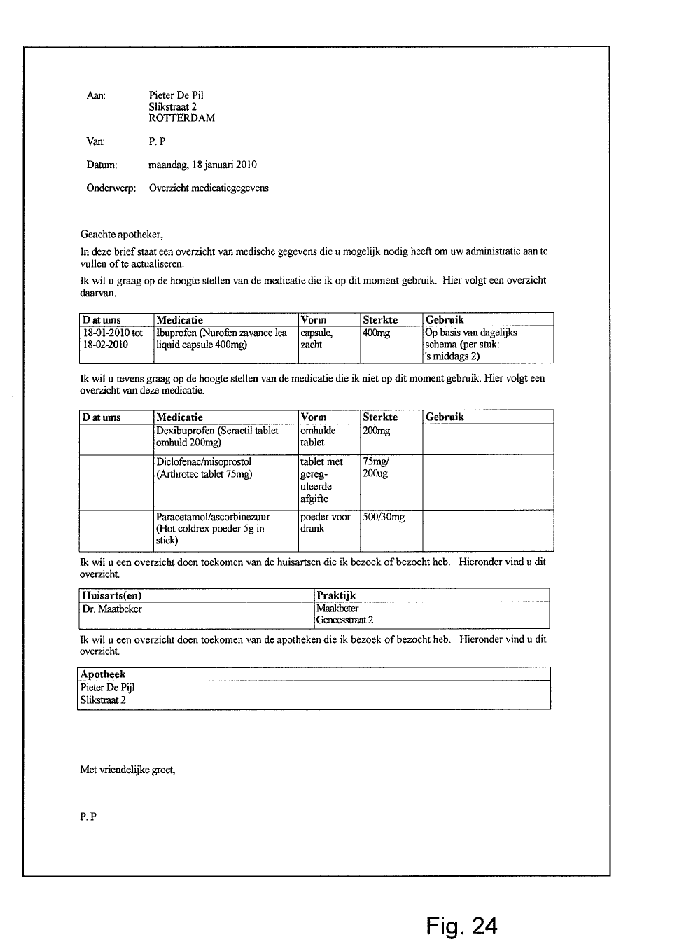

FIG. 24 shows a possible letter to a pharmacist based on information from the first database.

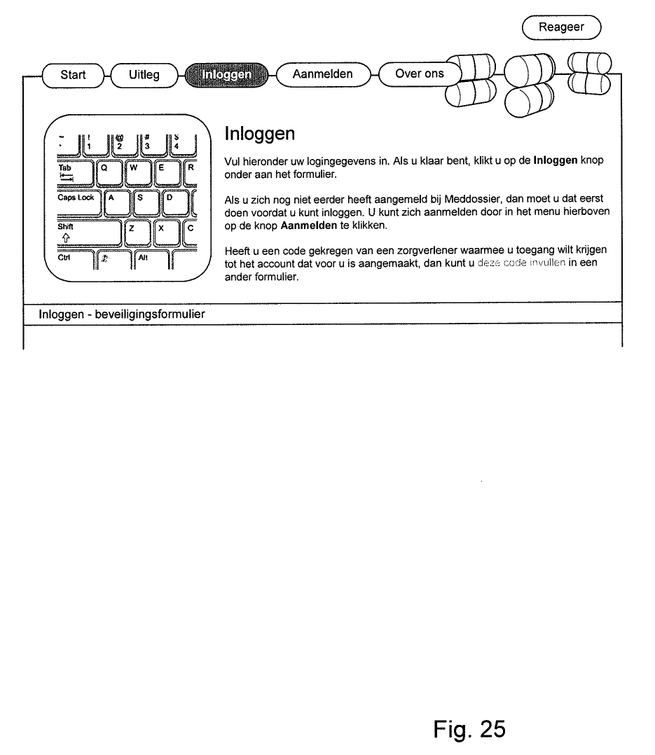

FIGS. 25, 26A, 26B, 27A, 27B, 27C, 28-37, 38A, 38B, 39-43 show fill-in and information-viewing screens of a particular embodiment of the invention.

In FIG. 1, with reference numeral 1 a computer system according to the invention for carrying out a method according to the invention is designated. The computer system in this example is provided with a computer 2 of a patient, which is set up, for example, at home. Further, the computer system is provided with a first server 4 and a second server 6. The computer 2 and the first server 4 in this example are connected with each other via internet 8. Likewise, in this example, the first server 4 and the second server 6 are connected with each other via internet 8.

On the first server 4 in this example a first database is stored in which a patient has stored information on the use of his personal medication coupled to information on the identity of the patient. This first database is designated with reference numeral 10. Further, in the second server 6 a second database 12 is stored in which standard information of known medications is stored. In this example, the second database is filled with information on medications according to the G-standard. Via his computer 2 a patient can store information on the use of his personal medication coupled to information on his identity. The first database thus comprises a personal medication file for the patient concerned. All this will be explained on the basis of an example in which the patient 14 wishes to store information on medication that he is using in his personal medication file. This proceeds as follows. First of all, the patient 14 accesses the database 10 with the aid of his computer 2. He can do this, for example, by entering his first name and last name. The server 4 will then ask the user 14, for example, for a password. The user 14 then sees the question: “enter your password” displayed on his computer 2. Then the patient 14 enters the password via the computer 2, which password is supplied via the internet connection 8 to the first server 4. The first server 4 checks on the basis of information in the database 10 whether the password is correct. When the password is correct, the patient gains access to his personal medication file which is stored in the first database 10. The patient then gets to see, for example, a screen with personal information such as name and address. If a patient wishes to enter a new medication, he can click the tab “medication” on his screen, whereupon a screen according to FIG. 2 is shown to him. The screen shows information on medications previously entered by the patient. The patient then energizes a button “add medication” with, for example, his mouse. Thereupon, he gets to see the screen as shown in FIG. 3. In the screen, at “characteristic of the medication” the patient can enter a keyword of the medication concerned. In this example, he enters Ibuprofen as keyword. Then he clicks on the button “search for medication”. After this, the picture according to FIG. 4 appears on his screen, which in this example is generated by the first server on the basis of information from the second database 12. So this involves standardized information. To this end, the first server has submitted Ibuprofen as search query, via the internet, to the second server. The second server 6 looks for hits relating to Ibuprofen in the second database 12. The information on these hits is sent by the second server to the first server. On the basis of this information the first server creates the screen according to FIG. 4 which is displayed on the computer 2 of the patient. Here, the patient sees that there may be two types of Ibuprofen, viz., Dexibuprofen and Ibuprofen. It is also indicated here that Ibuprofen is also known by the name of Antigrippine Ibuprofen. In this example, the user selects with his mouse the button “choose” associated with Ibuprofen. Based on the information from the second database the first server then generates a new fill-in screen according to FIG. 5 on the computer 2 of the patient. From this screen it appears that the patient must choose the form in which the medication is administered (such as melting tablet, Capsule, soft, etc.). In this example, the patient chooses Capsule, soft. After this, the fill-in screen according to FIG. 6 is generated. Here, the strength of the medication Ibuprofen must be chosen. He can choose between 200 mg and 400 mg. In this example, the patient chooses 200 mg by energizing the respective button associated with 200 mg. Based on the information from the second database, the first server then generates the screen as shown in FIG. 7 on the computer 2 of the patient. Now the patient must choose the supplier if he knows it. If he doesn't, he can choose: “I cannot choose”. In this example, he chooses the supplier “RECKITT BENCKISER HEALTHCARE B.V.” After this, the first server generates the screen according to FIG. 8 with information about the chosen medication. The patient can now stop entering if he so wishes. In the first database, information on the use of the medication Ibuprofen, coupled to the identity of the patient 14, is stored. However, the patient can also add information about the use of the medicament in question. To this end, he energizes the text “to indicate” in the screen of FIG. 8. Then the screen according to FIG. 9 appears, where the patient can enter the starting date and can indicate if this is an estimate or not. He can thereupon confirm the entered information by energizing the button “confirm”. Then the screen according to FIG. 10 appears where, if this is known, the final date of the period of use can be entered. In this example, as a date, 2010 Feb. 18 is entered. Also, it can again be indicated whether this is an estimate yes or no. After entering this information the button “final date entered” can be energized. If the final date were as yet unknown, the button “no final date yet” could be energized instead. If there is a single medicine use involved, the button “single use on 18 Jan. 2010” can be energized. After energization of one of the three buttons, the server 4 generates the fill-in screen according to FIG. 11. Here, the patient can indicate whether the use involved is a medication use exclusively at predetermined times, or a medication use when he needs it but not at predetermined times, or a medication use when he needs it and at predetermined times. In this example, the choice is medication use according to predetermined times. Thereupon the fill-in screen according to FIG. 12 appears. Here, the patient must indicate how the medication use repeats itself. He can choose between: “where this medication is concerned, every day is the same”, “where this medication is concerned, every week is the same”, “my use varies per day and week, but every month looks the same regarding use of the medication” or “the use does not fall into the above categories”. In this example, the patient energizes the button associated with “where this medication is concerned, every day is the same”. Then the fill-in screen according to FIG. 13 appears. Here, it is to be indicated how the medication is used per day. In this example, the patient fills in that he uses two items in the afternoon. After filling in the number 2 he confirms this by energizing the button “confirm”. Then the fill-in screen according to FIG. 14 appears. Here, the patient can enter the prescriber if applicable. The last option indicates the possibility that the medication has been prescribed by the general practitioner who is on record in the first database as being associated with the patient concerned. In this example, the patient chooses the last option, i.e., that the medication has been prescribed by Dr Maatbeker of the practice Maakbeter in Rotterdam. In this example, the patient concerned has previously stored in the first database who his general practitioner (family doctor) and pharmacist are. The patient can also choose the option “no, this medication has not been prescribed to me by anyone”, “no, this medication has been prescribed to me, but not by anyone from the list below”, or “my prescriber is not on the list yet, I wish to add the prescriber to the list”. After the patient has chosen the last option, the fill-in screen according to FIG. 15 appears. Here, if applicable, the patient can enter the pharmacy where he has obtained the medicament concerned. He can choose between the alternatives: “no, I have not obtained this medication via a pharmacy”, “no, I have obtained the medication via a pharmacist, but not via a pharmacist from the list below”, “my pharmacist is not on the list yet, I wish to add the pharmacy to the list”, or “yes, I have obtained the medication via Pieter de Pil from Rotterdam”.

In this example, the patient chooses the last alternative. Then the fill-in screen according to FIG. 16 appears, asking for still more information on the medication use. The patient can choose between “I have indeed a repeat prescription for this medication” or “I have no repeat prescription for this medication”. In this case the patient chooses the latter option. After this, the overview according to FIG. 17 appears which corresponds to the overview according to FIG. 2 except that the use of Ibuprofen has been added.

All information discussed hereinabove and entered along the lines of FIGS. 3-17 has now been added in the personal medication file of the patient 14. It is noted that the patient, if desired, can also enter yet other information. The screen of FIG. 2 could additionally comprise, for example, a button “other information”. When this button is energized, for example, a fill-in screen with a free field to be filled in is shown where this other information can be introduced. This can be carried out by the patient by typing in the field. Also, in a known manner, files (word documents, scans, photographs and the like) comprising this other information may be dragged into the free field by the patient so that these files are stored in the first database. This other information is again stored, coupled to the identity of the patient. The other information on the patient can comprise, for example, results of tests which have been performed on the patient, for example by the first entity, such as X-rays, MRI scans, CT scans and lab results.

From FIG. 17, it appears furthermore that the patient concerned already uses or has used Dexubiprofen, Dyclophenac and Paracetamol. Further information (such as use present or past, prescribed by whom, and the like) may be obtained per medication and be shown on the screen of the computer 2 (PC, laptop, iPad, etc.) by clicking on the medication in question.

Next, a patient, if he so wishes, can energize the button “add more medication” when he wishes to add a new use of a medication. An advantage is that in the medication file shown in FIG. 6 the information on the use of the medications is correctly and uniformly displayed and stored in the first database by the patient because the information concerned has been generated with the aid of the G-standard.

According to the invention, therefore, in a step a. a first database of the computer system is utilized in which by a patient information about the use of his personal medication, coupled to information on the identity of the patient, is stored. The system utilizes a second database of the computer system in which standard information of known medication is stored, while in step a. the patient utilizes information from the second database for filling the first database with standard information of a medication.

Also, it has appeared that in the entering of the information on the use of the medication by the patient, the computer system, on the basis of a keyword entered in the computer system by the patient, generates a list of possible medications and shows it to the patient, whereupon the patient chooses from the list a medication that corresponds to the medication that he uses, whereupon the selected information on the medication, coupled to the identity of the patient, is stored in the first database. When entering a medication used by him, the patient can also enter information on the frequency of taking a medicine of the medication, the form of the medicine, the strength of the medicine, the use of the medicine (for example, the period of taking the medicine), the origin of the medicine, the brand of the medicine, information on the storage life of the medicine (for example, not to be used after 1 Jan. 2015), and/or an identity of a person such as a physician or pharmacist, care institution, pharmacy and/or hospital that has prescribed and/or delivered the medication.

The computer system in this example is so arranged as to generate an alert to the patient when after entry of new information on a use of a medication in step a. it appears from the first database that the new information does not go together with the information from the first database on the use of a medication the patient already uses. In effect, this action is carried out by the first server. The first server knows what medications are already used by the patient and consults, for example, the second server to see if the new medication to be entered might present a problem (a problem such as contraindication) with the medications already used by the patient. The information on the incompatibility of the use of different medications can therefore be obtained by the first server, for example, from the second database of the second server.

In the foregoing the assumption has been that the patient already has access to the first database. The initiative for storing information of the patient in the first database and providing the patient access to the first database may lie, for example, with a first entity. What applies then, preferably, is that the first database in a step c. is initially filled with information of the patient by a first entity such as a physician and/or pharmacy and/or pharmacist and/or hospital and/or care institution, after which the first entity provides the patient access to his information in the first database. The first entity approaches the patient, for example via a letter, mail or personal interview, and asks whether the patient is interested in gaining access to his information in the first database. If the patient indicates he is interested in this, the first entity provides the patient access to his information in the first database (for example, by providing an access code to access the first database via internet). From that moment onwards, the patient can access the first database to consult it and/or to enter information on his use of medicines, as discussed above.

Providing access can be done when the patient has indicated that he is interested in this, for example, by means of a letter, mail or in a personal interview at the first entity. If the patient is not interested the first entity can himself/itself use the first database and no access is provided to the patient. In particular, after being created, the first database in a step d. is filled by the first entity with information on the identity of the patient. Next, in a step e., information on the use of the personal medication can, coupled to information on the identity of the patient, be stored in the first database by the first entity. It is noted that the first entity, if desired, can also enter yet other information. For this purpose, for example, use can be made of a fill-in screen with a free fill-in field where this other information can be introduced. This can be carried out by the first entity by typing in the field. Also, in a known manner, files (word documents, scans, photographs and the like) comprising this other information may be dragged into the free field by the first entity so that these data files are stored in the first database. This other information is again, coupled to the identity of the patient, stored. The other information on the patient can comprise, for example, results of tests which, for example, have been performed on the patient by the first entity, such as X-rays, MRI scans, CT scans and lab results. If the first entity has provided the patient access to the first database, the patient from that moment onwards can inspect the database. When the patient has no access to the first database, the patient can inspect the first database when he is present at the first entity and the first entity can employ the database exclusively for own use. Also, the first entity can inspect the database possibly in the presence of the patient and in consultation with the patient supplement and modify it or merely inspect it. When the patient indicates he is using or no longer using certain medicines, the first database may, for example, be modified accordingly.

In particular, in step e. the first entity utilizes the standard information from the second database for filling the first database. Preferably, here, in step e., information on the use of a medication is stored in the first database by the patient according to standard information from the second database on the medication to be entered. Preferably, in step e., in the entering of the information on the use of the medication by the first entity, the computer system, on the basis of a keyword entered by the first entity at the computer system, generates a list of possible medications and shows it to the first entity, whereupon the first entity selects from the list a medication that corresponds to the medication the patient uses, whereupon the selected information on the medication, coupled to the identity of the patient, is stored in the form of standard information in the first database.

In particular, it holds furthermore that the first entity in step e., of a medication the patient uses or has used, also enters information on the frequency of taking a medicine of the medication, the form of administration of the medicine, the strength of the medicine, the use of the medicine (for example, the period of taking the medicine), the origin of the medicine (supplier), the brand of the medicine, information on a storage life of a medicine, and/or an identity of a person such as a doctor or pharmacist, care institution, pharmacy and/or hospital that has prescribed the medication.

The patient may, if desired, decide to provide access to the first database to a second entity such as a physician and/or pharmacy and/or pharmacist and/or hospital and/or care institution, while, in particular, the patient also indicates which information the patient is providing the second entity access to. In particular, after providing the second entity access to the first database, information from the first database may be sent by e-mail or similar message to the second entity and/or the second entity is given an opportunity to obtain or consult information from the first database, for example, by downloading, printing or reading from a display.

The patient hence can, if he so wishes, communicate to the first server via his computer 2 that he is providing access to the part of the first database that relates to his person to, for example, a second entity such as a physician and/or a pharmacy and/or a pharmacist and/or hospital and/or care institution. This may be realized in a known manner in that the user protects his information with a password he gives to, for example, the general practitioner beforehand. Via his computer 16 the general practitioner can then access the first server 4 (for example, via internet), enter the identity of the patient, as well as the password in question, whereupon the medication file of the patient concerned becomes accessible for the computer 16. The password in question may, for example, afford a physician once-only access to information of the patient, afford access to information of the patient for a definite period of time, or afford access to information of the patient for an indefinite period of time. The patient can also indicate per entity to which information he is providing access. Thus, he can decide to provide a particular second entity mere access to information on medications from a particular period, for example, medications used in the period of 1990-2000. After this, for example, the general practitioner concerned may be granted an opportunity to download the information concerned from the database. It is also possible, however, that the patient arranges for information from the first database relating to his personal medication file to be sent to the computer 16 of, for example, the general practitioner, via an e-mail or an XML message, etc. Also, the second entity may be granted access by the patient to enter information on the patient, and coupled to the patient's identity, in the first database. This information can comprise the same information as can be entered in the first database by the patient and/or the first entity.

Also, it is possible that the patient requests an entity (the first entity, the second entity and/or a third entity such as a physician and/or pharmacy and/or pharmacist and/or hospital and/or care institution) to check information on medications from the first database that is coupled to the patient's identity. This can be carried out in different manners. For example, the patient can enter the request concerned at the first server. If at the first server in the first database information of, for example, the general practitioner is known, the first server can proceed to forward the request via, for example, the internet to the computer 16 of the general practitioner. The general practitioner can then, for example, download the information of the patient to check it and, if desired, contact the patient for consultation. Also, the patient can send this request directly to the computer 16 of the general practitioner, together with, for example, a password, so that the general practitioner himself, when it is convenient to him, can access the first server to retrieve the information from the personal medication file of the patient using the password concerned. After this, the general practitioner can assess this information and there can be, for example, consultation by telephone between the general practitioner and the patient.

Other ways of providing access are also conceivable. Suppose a general practitioner wishes to have access via his computer 16 to information of the patient stored in the first database. If the patient has not provided access to the general practitioner before, the general practitioner will be denied access. The patient can then provide the physician on the spot with a code giving the physician once-only permission to consult data of the patient in the first database. Also, the physician, when the patient is with him, can ask the first database with his computer 16 to send an SMS message with an access code to a mobile telephone of the patient. It holds here that the mobile telephone number of the patient is known at the first database. Upon receipt of the SMS message the patient can let the general practitioner know the access code, after which the general practitioner can feed this access code with his computer 16 to the first database. The first database then provides the computer 16 access when the received code corresponds to the code of the SMS message. Also, via a computer, for example, via the computer 16 of the physician whereat he is present, the patient himself, by entering a password, can gain access to the data stored about him, including account data. Upon access to his patient account, he can enter, for example, that the physician in question gets access to particular data or all data that are stored in the first database about him. Such access may again be once-only, for a definite period of time or an indefinite period of time.

Whatever the manner in which a patient has provided access to a general practitioner, or more generally to a second entity, the patient remains lord and master of the information stored about him in the first database. This appears, in this example, from the following: The second entity is provided access to information of the patient stored in the first database only when the patient has provided access to the second entity. The patient may, for example, provide the second entity permanent access, provide access for a definite period of time, or provide once-only access to information of the patient stored in the first database. In exceptional circumstances the second entity may nonetheless obtain access to information of the patient in the first database, also when the second entity has not obtained permission from the patient for this. Such a special circumstance may occur, for example, when the patient is in danger of life and is incapable of providing access to the second entity. In that case, however, it is preferred that the fact that the second entity has consulted information on the patient in the first database be stored in, for example, the first database, so that it can be verified later that the second entity has not taken advantage of the access obtained. Also, the patient may retract the access he has provided to the second entity. Thus the patient is and remains lord and master of the information stored about him in the first database.

In this example, the information on the identity of the patient is also stored in the first database. The information on the identity of the patient can comprise, in addition to his name and address, for example, age, sex, blood group or rhesus factor, the name of a general practitioner and/or the name of a pharmacist. All this information is then stored in the first database so as to be associated with the information on the use of medications of the patient concerned.

The patient can also, as desired, for a general practitioner or for a pharmacist, print out a standard letter based on information from the first database about the use of medication and about the use of medication in the past. For this purpose, he energizes the tab “print”, whereupon the screen according to FIG. 18 is generated on the computer 2 by the first server. This screen shows that the patient can choose between printing information for himself, for a general practitioner, or for a pharmacist. When the patient energizes the button relating to “for myself”, a fill-in screen according to FIG. 19 is shown. Here, the patient can choose what he wishes to print: “list of current medication”, “list of medication you don't use anymore”. “list of pharmacies you go to”, and “list of general practitioners you go to”. Also, a tick may be provided to indicate that all is to be printed. In this example, the choice is for all to be printed out. Then the button “make the printout” is energized. Thereupon a printout is made according to FIG. 20. What holds more generally, therefore, is that the patient obtains, can obtain or consults information from the first database, for example, by downloading, printing or reading from a display. This information then relates to information of the patient, not to information of other patients in the first database.

When in the fill-in screen according to FIG. 18 it is chosen that information be printed for a general practitioner, the fill-in screen according to FIG. 21 appears. Here, too, a choice is offered between options of what is going to be printed, such as: “your name information”, “list of current medication”, “list of medication you are no longer using”, “list of pharmacies that you go to”, “list of general practitioners that you go to”. Also, it is possible to tick off a command to print all. Also, in addition, the salutation of the letter may be chosen, as in this case “Dear doctor”. After this, the choices made can be confirmed by pressing the button “make the printout”. Then a letter according to FIG. 22 is printed on a printer which is connected to the computer 2. In this letter, it is clear that the only medicament that is still used is Ibuprofen; the other medications are medications from the past. Also, it is indicated who the general practitioner is and which is the pharmacy. When, by contrast, it is chosen in FIG. 18 that a letter for a pharmacy be printed, the screen according to FIG. 23 appears. Here are the same printing options as discussed in relation to the general practitioner. In this example, it is again chosen to print all. When thereupon the button “make the printout” is energized, a letter according to FIG. 24 addressed to the pharmacist is printed.

Such variants are each understood to fall within the invention. In the foregoing it has already been indicated how the first entity may first store data of the patient in the first database, how access to the first database may be provided by the first entity to the patient for accessing data of the patient that are stored in the first database, how the patient can then enter in the computer system to what extent (definite period, indefinite period or once-only) the first entity retains access to data of the patient that are stored in the first database and, possibly, how the patient, if desired, can provide the second entity access to the data of the patient that are stored in the first database, in which case, possibly, the patient can proceed to enter in the computer system to what extent (definite period, indefinite period or once-only) the second entity has access to data of the patient that are stored in the first database.

Of course, also the patient himself can in a step c. initially fill the first database with information of the patient. In that case the patient can go, for example via the internet, to a web page of the first database. The patient can indicate there that he wishes to store his information in the first database. This can mean, for example, that the patient in a step d. fills the first database with information on the identity of the patient. Also, the patient may then, in a step e., store information on the use of his personal medication, coupled to the information on his identity, in the first database.

The patient can then also enter a password, with which the data are protected. When filling the first database, the patient again utilizes the standard information from the second database as discussed hereinabove. After the patient has logged out, he can return via the Internet to the website in question again. When he wishes to access his data, he will then first need to enter the password he himself has specified.

In particular, it also holds that in step e. information about the use of the medication is stored in the first database by the patient according to standard information from the second database on the medication to be entered.

How all of this works will be shown hereinafter.

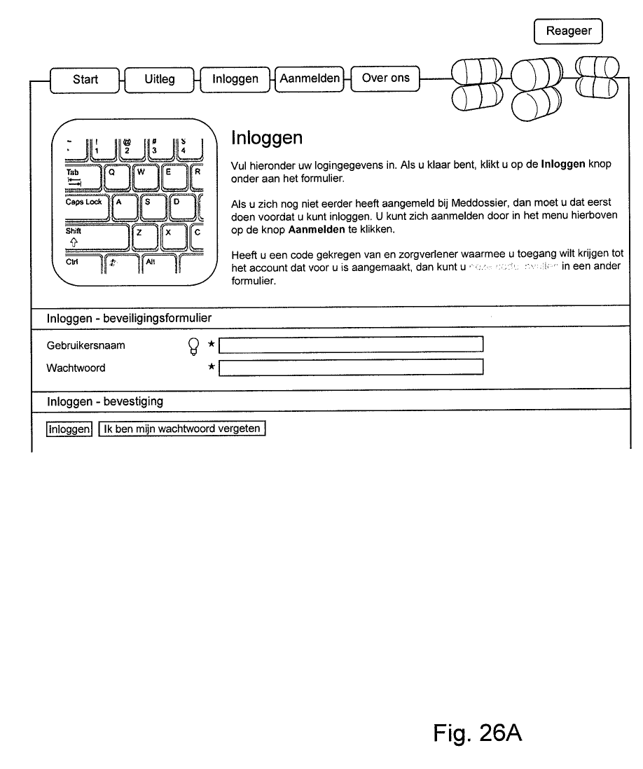

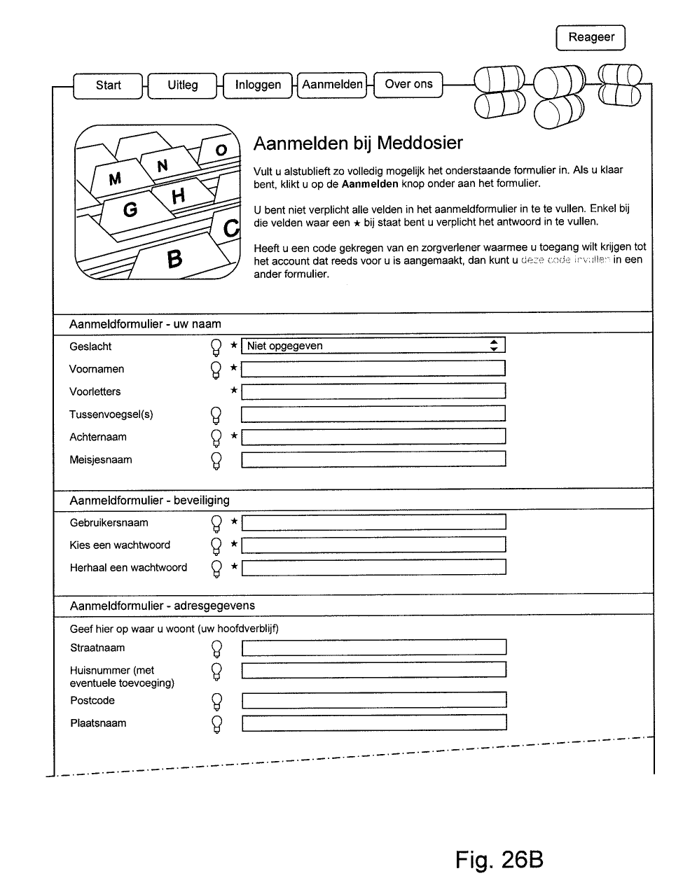

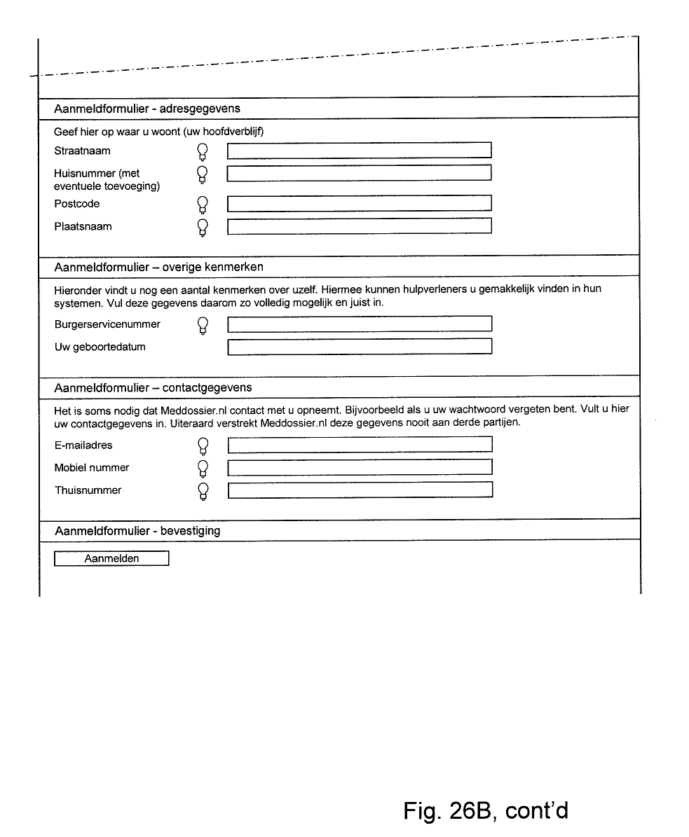

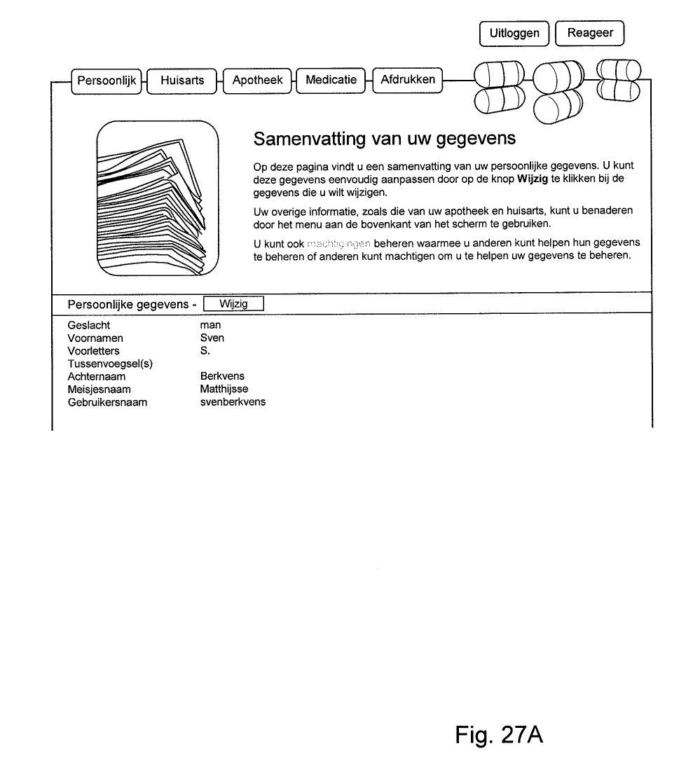

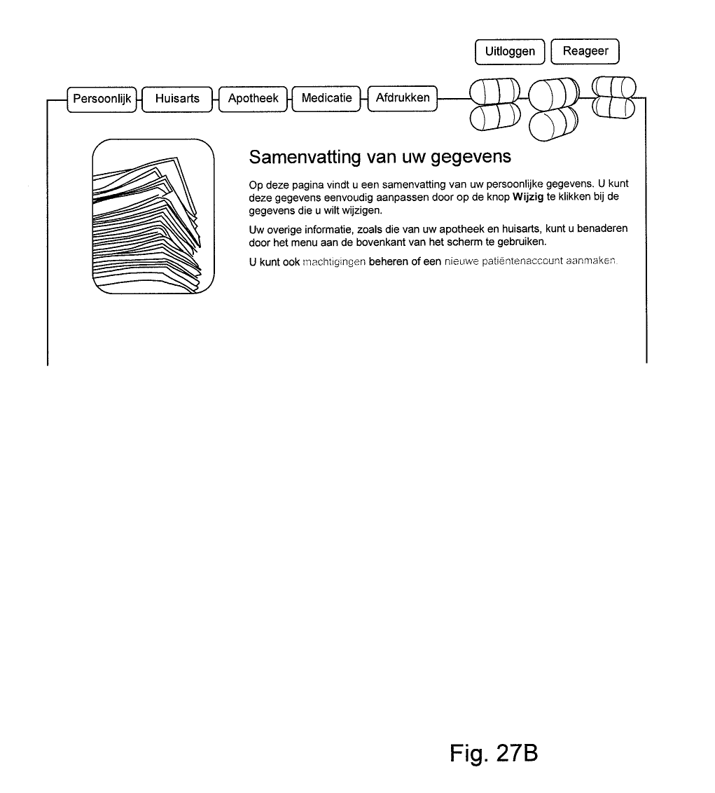

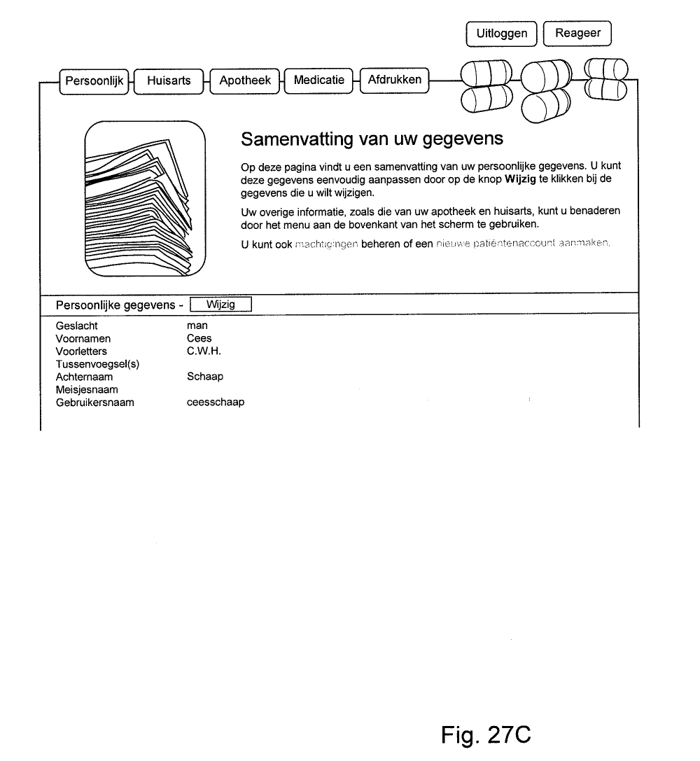

In FIG. 25 the initial screen is shown that a patient sees when on his computer 2 he goes to the website named “meddossier.nl”, which website can provide access to the first database. The patient here has the option of energizing the button “Log In” if the patient has earlier obtained access to his data stored in the first database. After the button “Log In” has been energized, a screen appears (see FIG. 26A) in which the patient must fill in, for example, his name and address details and/or a user name as well as a password (in the password field). After logging in, the screen according to FIG. 27A appears. From this screen, the patient can gain access to his data stored in the first database, as has been discussed with reference to FIGS. 2-24. If, for example, in the screen of FIG. 27A the button ‘medication’ is energized, the screen of FIG. 2 appears.

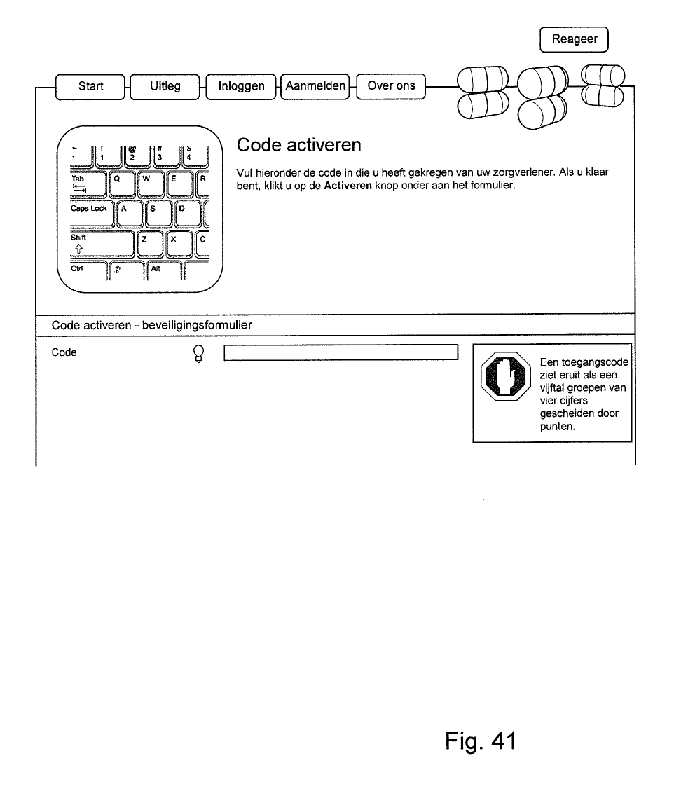

In the screen of FIG. 25, the patient can also energize the button “fill in this code” if the patient wishes to gain access to his data first entered by a first entity such as a physician. ‘Button’ is here understood to cover a hyperlink in a text passage which, for example, is of a color different from the rest of the text (see, for example, “fill in this code” in FIG. 25). In that case, the first entity has created an account for the patient in the first database. After this, the patient has obtained an access code from the first entity in order for himself to obtain access to his data in the first database. This will be discussed hereinafter with reference to FIGS. 41-43.

Since in this case, however, the patient 14 himself wishes to register for the first time at the first database (wishes to create an account himself), the patient energizes the button “Register” in the screen of FIG. 25 and thus ends up in the screen in which he can fill in his name and address details and/or a user name (see FIG. 26B). Also, in this screen the patient is asked to type a password (in the password field). In this example, the password has to be typed twice. After the password has been typed, the patient energizes the password by pressing the button “Register”. After this, the patient can navigate via the screen of FIG. 25 to the screen of FIG. 26A to log in on his just-created account. After login, the screen according to FIG. 27A appears, as discussed above. Then, the patient can add medications in the system or review them by energizing the button “medication” in the screen of FIG. 27A, whereupon a screen is shown to him such as shown in FIG. 2. Adding medication then proceeds entirely analogously to the procedure discussed above with reference to FIGS. 2-17. Also, the patient can then perform the operations described hereinabove with reference to FIGS. 18-24.

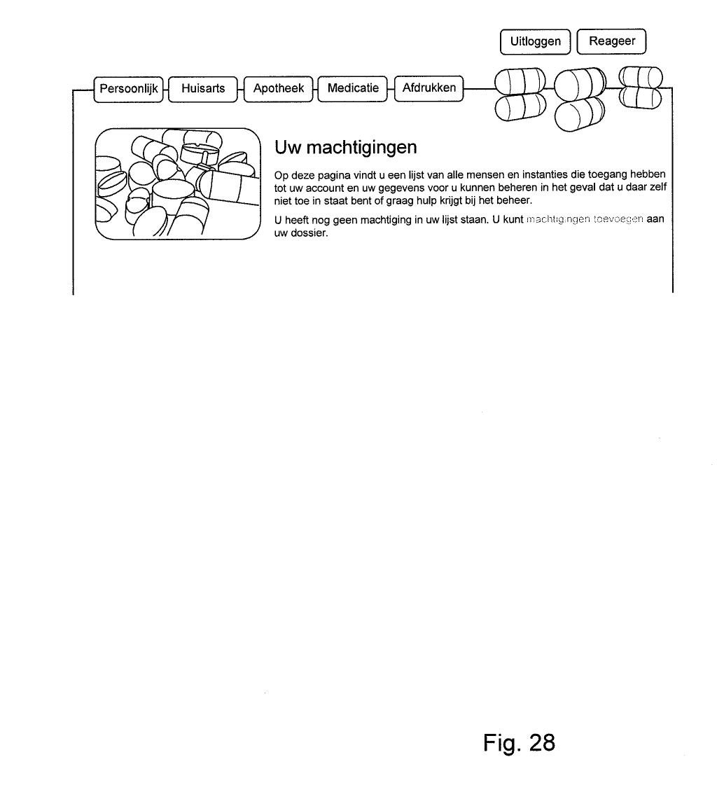

Also, the patient can manage authorizations by energizing the button “authorizations” in the screen of FIG. 27A , whereupon the screen according to FIG. 28 appears, as will be further discussed hereinafter.

When the patient visits the website a next time, he can energize the button “Log in” in the screen according to FIG. 25, whereupon, in the screen of FIG. 26A, he can enter his name and address details and/or user name and password to gain access, via the screen of FIG. 27A, to his data in the first database. After the patient has entered his name and address details and password (in the field password of the screen of FIG. 26A) in the system, the patient can add medications in the system by energizing the button “medication” in the screen of FIG. 27A, whereupon he is shown a screen as shown in FIG. 2. Adding medication then proceeds entirely analogously to the procedure as discussed with reference to FIGS. 2-17. Also, the patient can then perform the operations described hereinabove with reference to FIGS. 18-24.

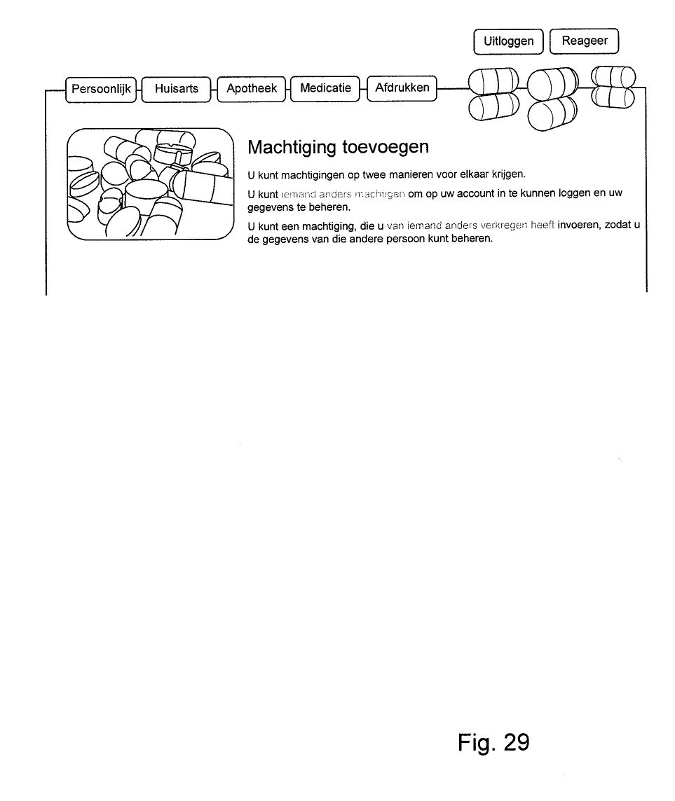

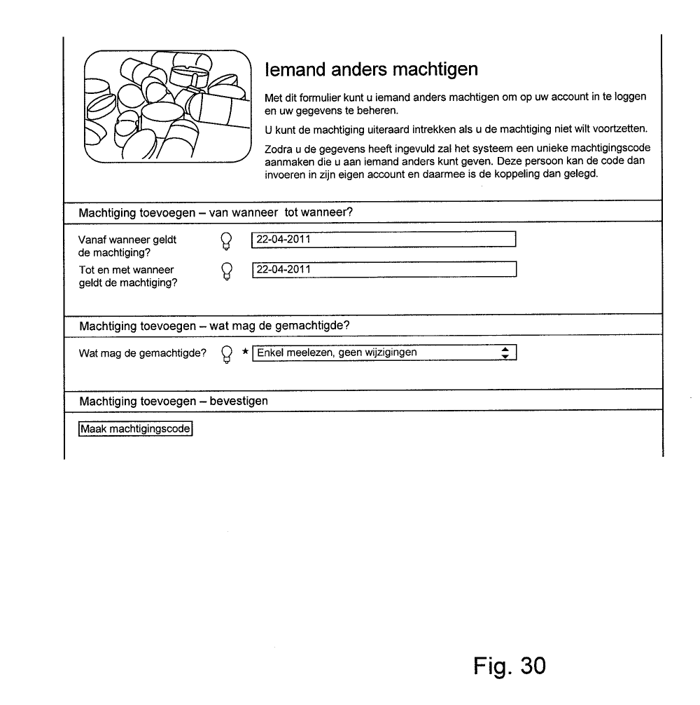

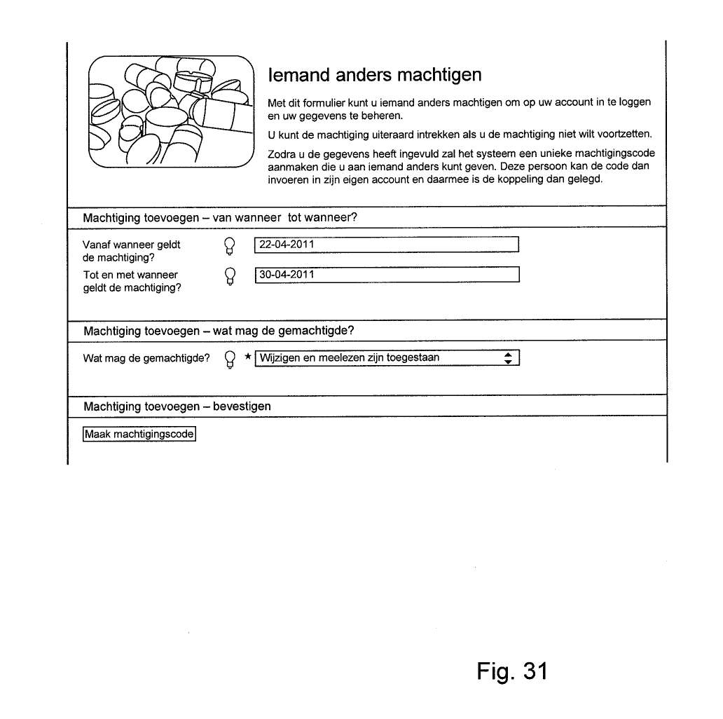

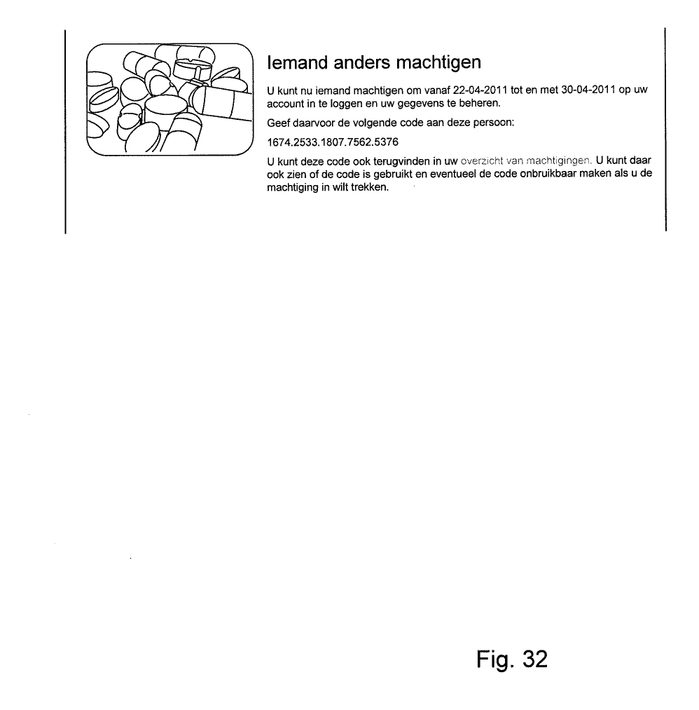

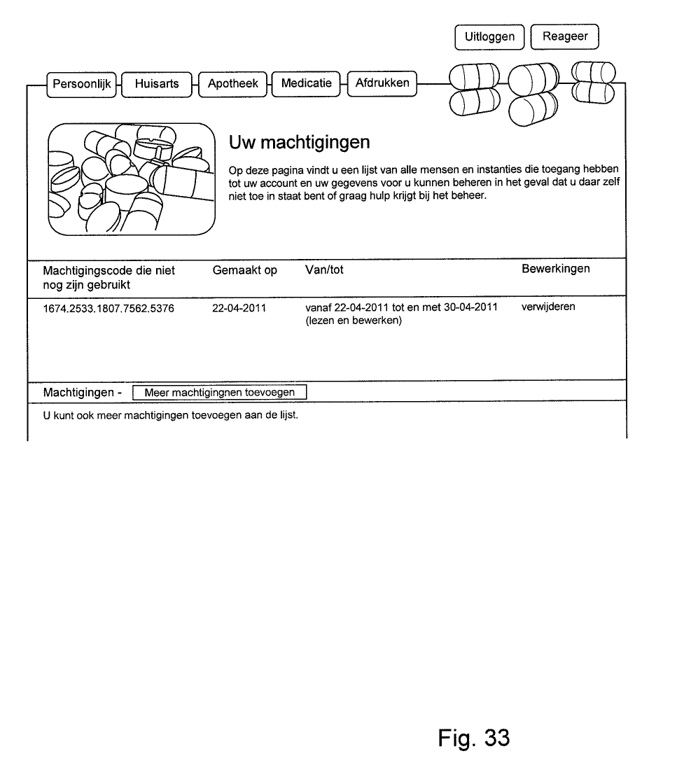

Once a patient has stored his data in the first database, he can also issue authorizations to third parties for them to consult his data. For this purpose, the patient energizes the button “authorizations” in the screen of FIG. 27A. The patient is then presented a screen as shown in FIG. 28. In the screen of FIG. 28 a list of authorizations is given. In this case, the screen is empty, which means that no authorizations have been issued yet. The patient can now add authorizations by energizing “add authorizations”, for example, with the mouse. After energization of “add authorizations”, the screen of FIG. 29 appears. This screen shows that the patient can choose between “authorize someone else” or entering an authorization (you) “have obtained from someone else”. In this case the patient energizes “authorize someone else”, whereupon the screen of FIG. 30 appears. In the screen of FIG. 30 it is indicated by default setting that the authorization starts and ends on the current date, viz. 22 Apr. 2011. The patient, however, changes the default values such that the authorization expires on 30 Apr. 2011. It was also indicated by default setting that the authorized entity is authorized to read-only and not to make any changes. The patient changes this to “reading and making changes are allowed”. All this is shown in FIG. 31. After the patient has made the changes concerned, he energizes the button “create authorization code”. Then the screen according to FIG. 32 appears. The computer system is arranged so as to generate an authorization code, which is designated in FIG. 32 as “1674.2533.1807.7562.5376”. The intention is for the patient to give this authorization code to, for example, a second entity such as a pharmacy he wishes to authorize to gain access to his data. When the patient thereupon energizes the button “overview of authorizations”, the computer system generates the screen according to FIG. 33 (corresponds to the screen of FIG. 28, though with an updated content). Here it is indicated what authorization code has been issued, when it was issued, and until when it is valid. Also, it is indicated that the code entitles to reading and editing. Also, it appears that the authorization code concerned has not been used yet by the second entity. Further, it is possible that the patient, by pressing the button “remove”, withdraws the authorization code again. Also, if he so desires, the patient, by pressing the button “add more authorizations”, can furnish an authorization to other entities, whereupon once again FIGS. 30-33 are traversed as described hereinabove.

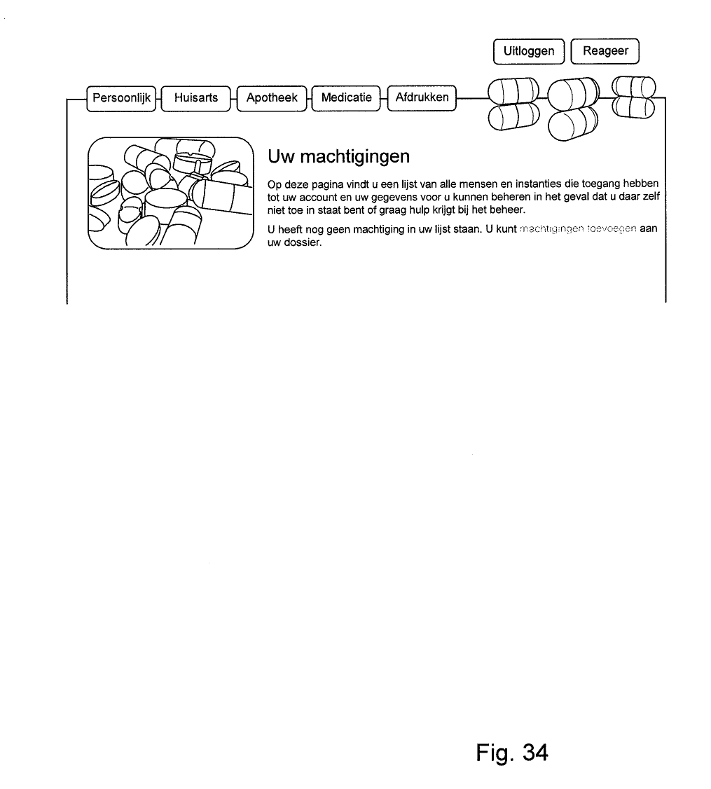

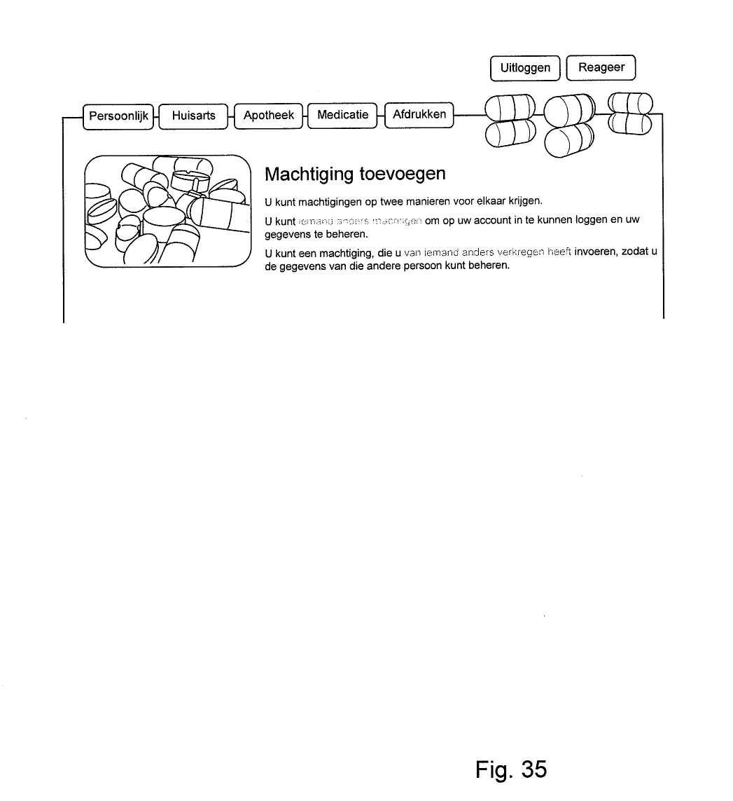

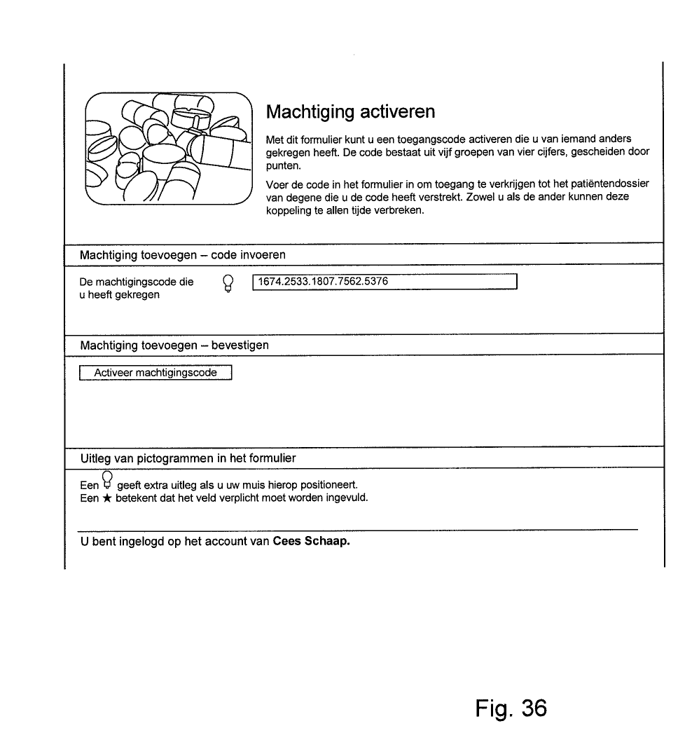

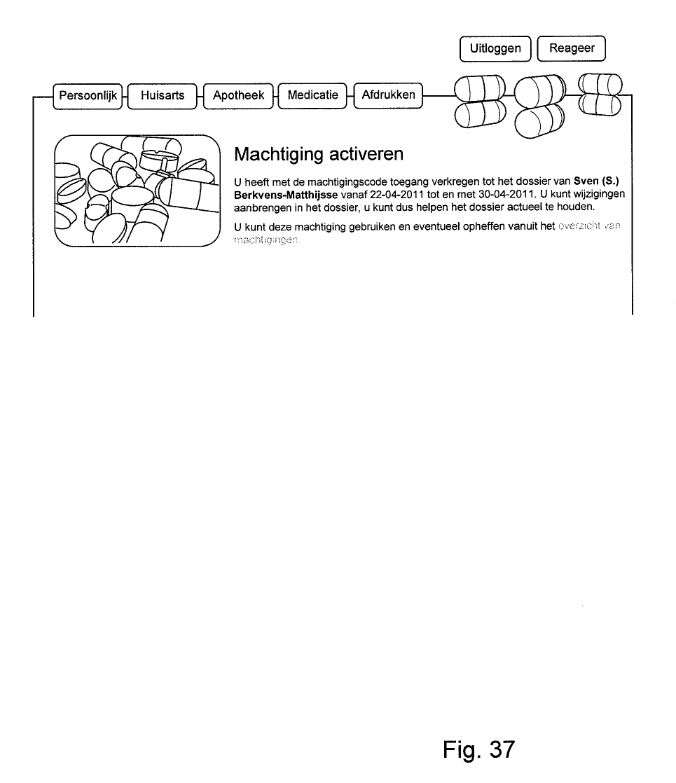

When the second entity has received the authorization code from the patient, the second entity, just like the patient, can access the first database via Internet by going to the webpage of “meddossier.nl”. The second entity can access the first database via an own computer, which is not indicated in FIG. 1 for simplicity, but whose situation is similar to that of the computer 2 and the computer 16. The second entity can only obtain access to the first database when the second entity himself has already stored at least his name and address details in the first database. For this purpose, the second entity, just like the patient did at some point, has created his own account and created and then entered a password. The second entity accordingly opens his data by energizing in the screen as shown in FIG. 25 the button “Log in”, whereupon, in the screen of FIG. 26A, he can enter his name and address details and/or user name and his password. After this has been done, the screen according to FIG. 27C appears. In this screen the second entity can press the button “authorizations”, whereupon he is presented with the screen according to FIG. 34 (corresponds to the screen according to FIGS. 28 and 33, but now for the second entity). After this, the second entity can press “add authorizations”, whereupon the screen of FIG. 35 is shown to the second entity. In the screen according to FIG. 35 the second entity can energize the button “have obtained from someone else”. Then the screen according to FIG. 36 appears on his computer. In this screen the second entity can fill in the authorization code “1674.2533.1807.7562.5376”. The second entity “the pharmacist Cees Schaap” can then energize the button “activate authorization code”. Then the screen according to FIG. 37 appears on the computer of the second entity. This shows that the second entity “Cees Schaap” has obtained access to the file of the patient “Sven Berkvens-Matthijsse”. When the second entity has obtained access to the file of the patient, he can proceed to consult and/or change the content of this file, as has been discussed with reference to FIGS. 2-17. Also, the operations that have been discussed with reference to FIGS. 18-24 may be performed.

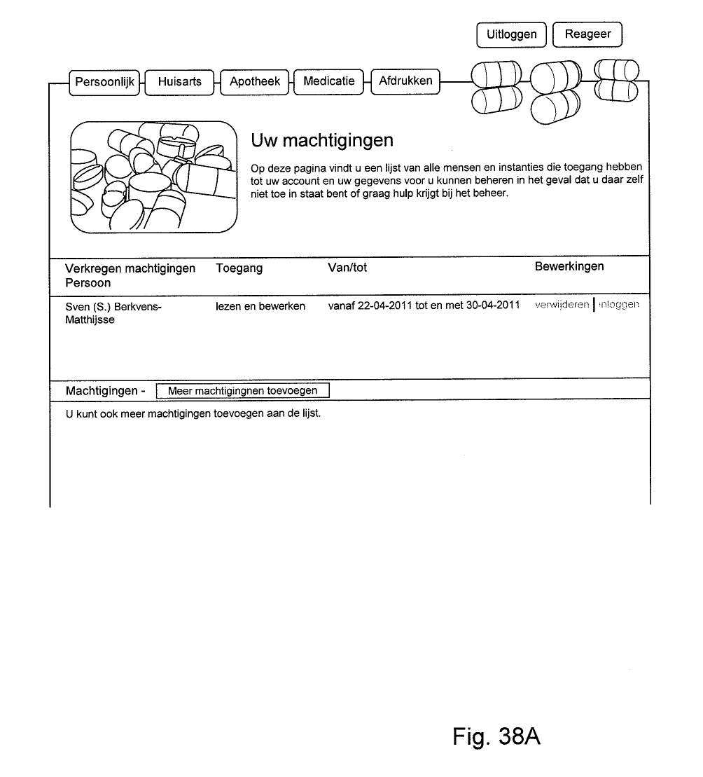

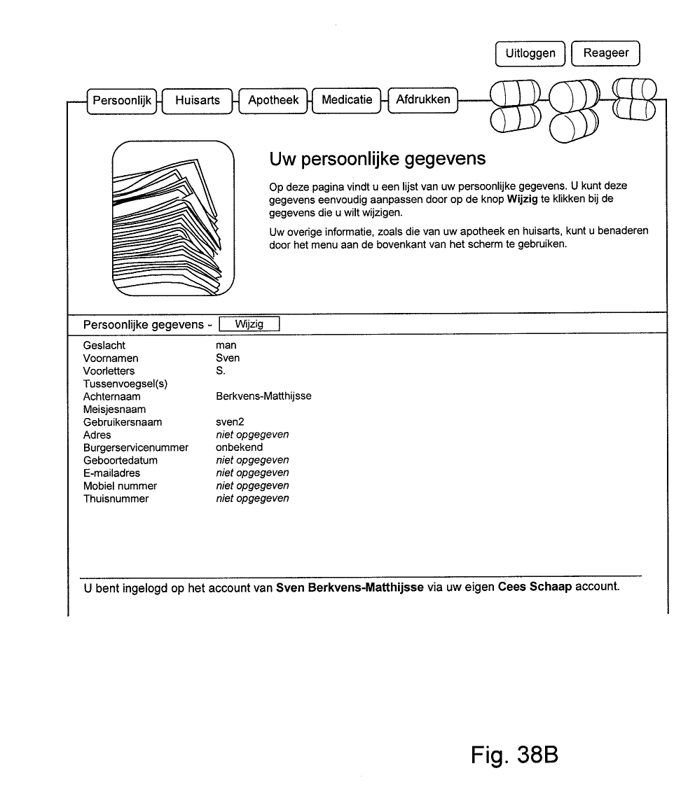

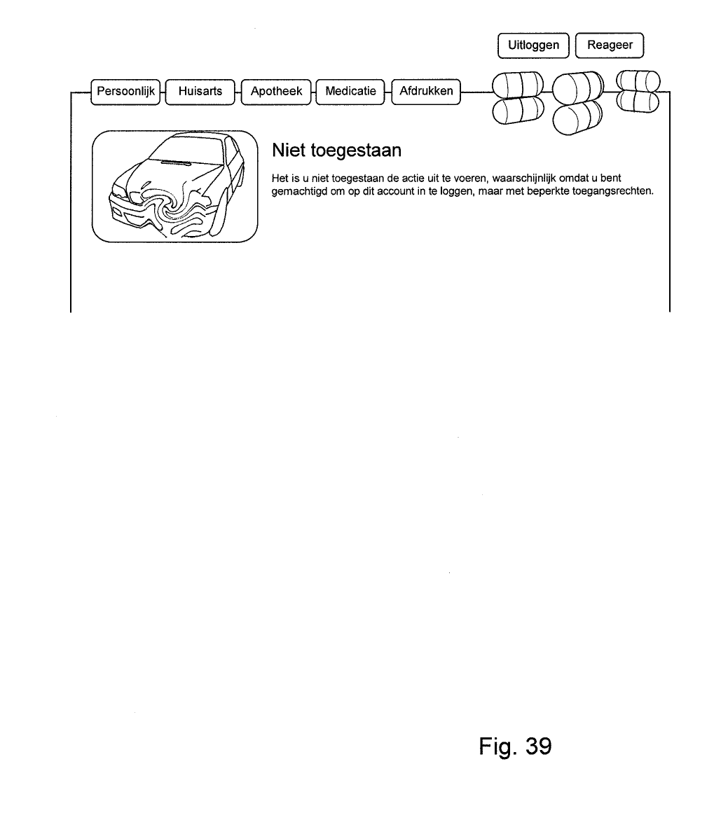

When thereupon the second entity presses the button “overview of authorizations”, the screen according to FIG. 38A appears. This screen shows from whom the second entity (Cees Schaap) has obtained authorizations, (from “Sven Berkvens—Matthijsse”), what the status of the authorization is, i.e., “reading and editing”, and that the authorization is valid from 22-30 April. When the second entity actually wishes to inspect and change the medication file of Sven Berkvens—Matthijsse (the patient), he must presently press the button “log in” in the screen of FIG. 38. This prompts automatic login on the medication file of the patient, whereupon, via the screen of FIG. 38B, data of the patient can be edited and read as already set out with reference to FIGS. 2-24. This can be done, for example, by energizing the button ‘medication’. If, for example, the second entity had not obtained permission to edit the data but tries to do so anyway, he will be shown a page according to FIG. 39. This page shows clearly that the editing operation is not allowed.

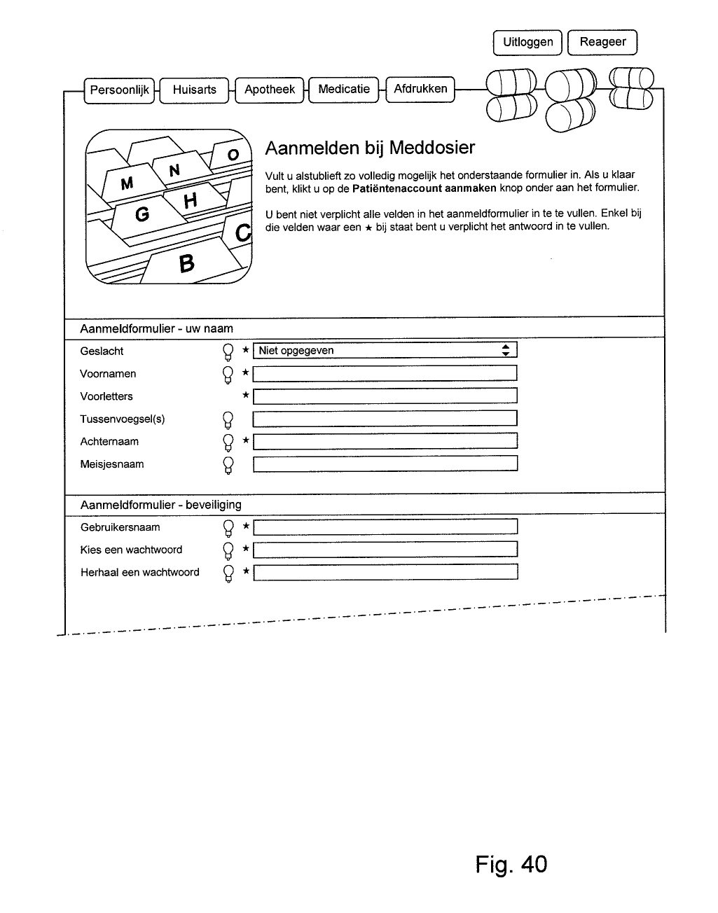

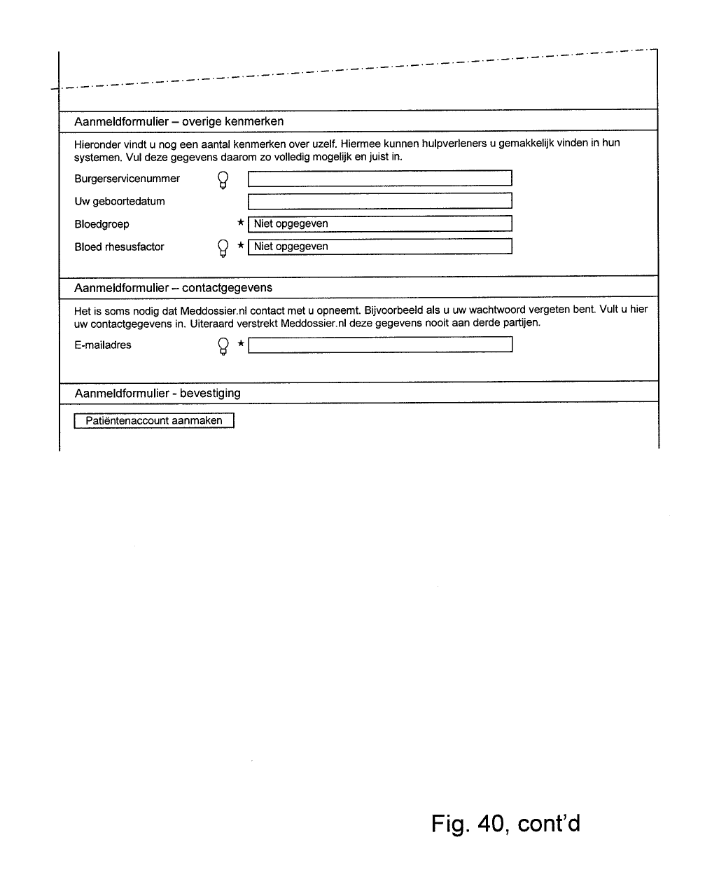

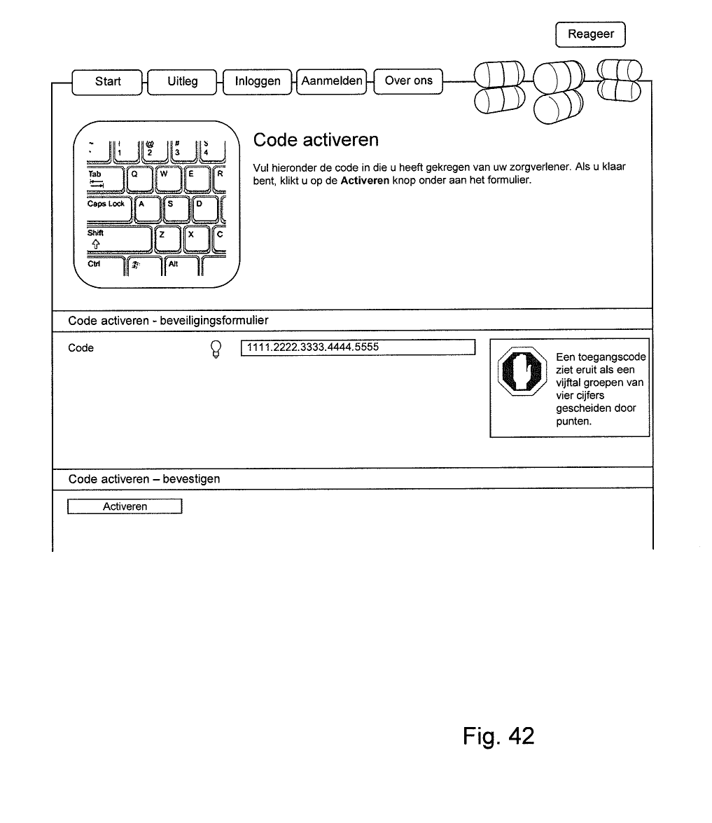

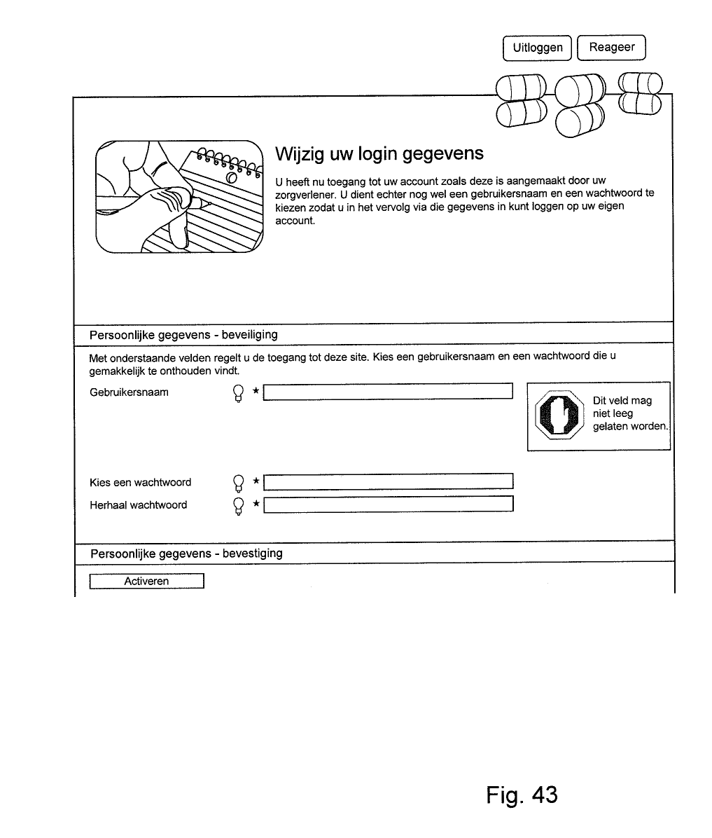

In the foregoing example it has been assumed that the patient himself has set up his medication file in a first step c., d. and e. It is also possible, however, that this is done by, for example, a first entity such as a physician whom the patient is visiting. Via his computer, the physician has already obtained access to the first database via the website “meddossier.nl” from the starting screen as shown in FIG. 25. When logging in , the first entity then used the screen according to FIG. 26A, as described hereinabove for the patient and the second entity. Thereupon the screen according to FIG. 27B appears because the system knows that the first entity is a care provider. In this screen according to FIG. 27B the first entity energizes the button “create new patient account”, whereupon the system shows a fill-in screen as shown in FIG. 40 on the computer of the physician. In this fill-in screen, the first entity fills in name and address details of the patient. In this screen the system generates an access code, which is once-only in this example. This access code, which is generated by the system, is read from the screen by the first entity and given to the patient. Evidently, this access code may also be communicated to the patient in a different manner, for example, via an SMS message or e-mail. Also, the first entity can now, as has been discussed with reference to FIGS. 2-24, enter data of the patient at the database. It holds that the first entity is automatically authorized to access the data now stored in the first database of the patient. Then, for example, the patient goes home and on his computer goes to the website of “meddossier.n1”. From the starting screen of FIG. 25, he energizes the button “fill in this code”. The system then generates the screen according to FIG. 41. Here, the patient can enter the access code which he has obtained from the first entity. The patient thereupon fills in the access code “1111.2222.3333.4444.5555” (FIG. 42) and energizes the button “Activate”. Then the screen according to FIG. 43 appears. Here the patient can enter a user name (hereinbefore also designated as name and address details) and the same password twice. Then the patient energizes the button ‘activate’. From that moment onwards, the patient can log in via the screen according to FIG. 25, FIG. 26A and FIG. 27A on the basis of his user name and password. By pressing the button “authorizations”, a screen as shown in FIG. 28 appears, listing to whom authorizations have been given. In this case, it would then appear that the first entity who in steps c., d. and e. has initially stored data of the patient in the first database, was automatically authorized. In this regard, for that matter, there are two possibilities. At the moment when the first entity performs the steps c., d., and e., he can also indicate, in consultation with the patient, what the nature is of his automatic authorization, such as, reading-only, reading and writing, or full access or access to a part of the information of the patient. Also, it may be indicated whether the authorization is for a definite or for an indefinite period of time. When nothing is indicated, it is assumed that the authorization is a full authorization and for an indefinite period of time. When the patient is logged in on the computer system to consult his data which are stored in the first database, he can see, when he presses the button “authorizations”, that the first entity has access for reading and editing and, for example, has access for an indefinite period of time. If he so wishes, he can remove or alter the authorization, for example, by changing the access for reading and editing to reading-only and/or, for example, by changing the access for an indefinite period of time to an access for a definite period of time. He can do so by energizing the respective fields with a mouse click.

The invention is not limited in any way to the embodiments outlined above. Thus, when a patient enters a new use of a medication, while this is in conflict with earlier-entered medication, for example, because two medications do not go together and may lead to hazardous reactions in a patient, the computer system is arranged to automatically send an alert to the pharmacist or the general practitioner of the patient if it is stored in the first database who the general practitioner is and/or who the pharmacist of the patient is. If more than one general practitioner and/or more than one pharmacist is coupled to the identity of the patient concerned, then, for example, each of the pharmacists and/or each of the general practitioners may be automatically sent an e-mail regarding the fact that the patient apparently uses, or is going to use, a medication that is in conflict with medications he is using at the moment. Furthermore, the first server and the second server may be replaced with one single server on which the first database and the second database are stored. Also, it is possible that the patient sends information on his use of a medication, for example on paper or in a memory stick, to a manager of the first database, whereupon the manager enters the medication at the first database, the patient first having utilized the second database for obtaining standard information on the medication to be entered and/or the manager utilizing the second database for entering the medication at the first database as standard information on the medication. The manager of the network may be, for example, the first entity. A first entity, and/or the second entity can access the first server and/or the second server, for example, via the professional network E-care.

In that case, via his computer 2 the patient then accesses the first server via the public internet. Such variants are each understood to fall within the framework of the invention.

1. A method for creating and/or keeping a personal medication file with the aid of a computer system, comprising:
a. utilizing a first database of the computer system, wherein by a patient information on the use of his personal medication, coupled to information on the identity of the patient, is stored in the first database, characterized in that the method further comprises:
b. utilizing a second database of the computer system in which standard information of known medications is stored, wherein in step a. the patient utilizes the standard information from the second database for filling the first database.

2. The method according to claim 1, wherein a medication is stored in the first database by the patient according to standard information from the second database on the medication to be entered.

3. The method according to claim 1, characterized in that in the entering of the information on the use of the medication by the patient, the computer system, on the basis of a keyword entered by the patient at the computer system, generates a list of information on possible medications and shows it to the patient, whereupon the patient selects from the list a medication that corresponds to the medication that he uses, whereupon the selected information on the medication, coupled to the identity of the patient, is stored in the first database in the form of standard information.

4. The method according to claim 1, characterized in that the patient, of a medication that he uses or has used, also enters information on the frequency of taking the medication, the form of administration of the medication, the strength of the medication, the use of the medication (for example, the period of taking the medication), the origin of the medication (supplier), the brand of the medication, information on a storage life of the medication, and/or an identity of a person such as a doctor or pharmacist, care institution, pharmacy and/or hospital that has prescribed the medication.

5. The method according to claim 1, characterized in that the computer system generates an alert for the patient when after the entering of new information on a medication used in step a. it appears from the first database that the new information does not go together with information from the first database on the use of a medication that the patient already uses.

6. The method according to claim 1, characterized in that the first database in a step c. is initially filled with information of the patient by a first entity such as a physician and/or pharmacy and/or pharmacist and/or hospital and/or care institution, after which the first entity, for example when the patient indicates he so wishes, provides the patient access to his information in the first database or that the first database in a step c. is initially filled with information of the patient by the patient.

7. The method according to claim 6, characterized in that the first database in a step d. is filled by the first entity or by the patient with information on the identity of the patient.

8. The method according to claim 6, characterized in that in a step e., by the first entity or by the patient, information on the use of the personal medication and/or other information on the patient such as information on tests performed on the patient, for example by the first entity, coupled to information on the identity of the patient, is stored in the first database.

9. The method according to claim 8, characterized in that in step e. the first entity or the patient utilizes the standard information from the second database for filling the first database.

10. The method according to claim 9, characterized in that in step e. information on the use of a medication is stored in the first database by the first entity or by the patient according to standard information from the second database on the medication to be entered.

11. The method according to claim 9, characterized in that in step e. in the entering of the information on the use of the medication by the first entity, the computer system, on the basis of a keyword entered by the first entity at the computer system, generates a list of information on possible medications and shows it to the first entity, whereupon the first entity selects from the list a medication that corresponds to the medication that the patient uses, whereupon the selected information on the medication, coupled to the identity of the patient, is stored in the first database in the form of standard information or that in the entering of the information on the use of the medication by the patient, the computer system, on the basis of a keyword entered by the patient at the computer system, generates a list of information on possible medications and shows it to the patient, whereupon the patient selects from the list a medication that corresponds to the medication that the patient uses, whereupon the selected information on the medication, coupled to the identity of the patient, is stored in the form of standard information in the first database.

12. The method according to claim 9, characterized in that the first entity or the patient in step e., of a medication that the patient uses of has used, also enters information on the frequency of taking of a medicine of the medication, the form of administration of the medicine, the strength of the medicine, the use of the medicine (for example, the period of taking the medicine), the origin of the medicine (supplier), the brand of the medicine, information on a storage life of the medicine, and/or an identity of a person such as a doctor or pharmacist, care institution, pharmacy and/or hospital that has prescribed the medication.

13. The method according to claim 1, characterized in that the patient obtains, can obtain or consults information on his medication from the first database, for example, by downloading, printing or reading from a display.

14. The method according to claim 1, characterized in that the patient provides access to his information in the first database to a second entity such as a physician and/or pharmacy and/or pharmacist and/or hospital and/or care institution, while, in particular, the patient also indicates which information the patient provides the second entity access to.

15. The method according to claim 14, characterized in that after the provision of access to the first database by the patient to the second entity, information on the patient from the first database is sent by e-mail or similar message to the second entity and/or that the second entity is granted an opportunity to obtain or consult information on the patient from the first database, for example, by downloading, printing or reading from a display.

16. The method according to claim 13, characterized in that the second entity is provided access to information of the patient stored in the first database only when the patient has provided access to the second entity, whereby, for example, the patient provides the second entity access to information of the patient stored in the first database permanently, for a definite period of time or once-only.

17. The method according to claim 16, characterized in that the second entity in exceptional circumstances, for example, when the patient is in danger of life, yet obtains access to information of the patient stored in the first database, in which case, however, the fact that the second entity has consulted information on the patient in the first database is stored in, for example, the first database so that it may be verified later that the second entity has not taken advantage of the access provided.

18. The method according to claim 1, characterized in that the patient withdraws the access he has provided to the second entity again.

19. The method according to claim 8, characterized in that the patient via the computer system requests the first entity, the second entity and/or a third entity such as a physician and/or pharmacy and/or pharmacist and/or hospital and/or care institution to check information on medications from the first database which is coupled to the identity of the patient.

20. The method according to claim 19, characterized in that the first database is stored on a first server of the computer system and the second database is stored on a second server of the computer system.

21. The method according to claim 20, characterized in that in step a. the patient; and/or in step c., d., and/or e. the first entity or the patient; and/or the second entity; access(es) the first server and/or the second server via internet with the aid of a computer.

22. The method according to claim 21, characterized in that the first entity or the patient; and/or the second entity; and/or the third entity; access(es) the first server and/or the second server via the professional network E-care.

23. The method according to claim 20, characterized in that the first server accesses the second server, for example via internet, for obtaining the standard information on medications which the patient or the first entity or the second entity utilizes via the first server for entering the medication of the patient in the first database.

24. The method according to claim 1, characterized in that the patient sends information on his use of a medication, for example on paper or in a memory stick, to a manager of the first database, whereupon the manager enters the medication at the first database, while the patient has first utilized the second database for obtaining standard information on medication to be entered and/or while the manager utilizes the second database for entering the medication at the first database with standard information on the medication.

25. The method according to claim 6, characterized in that the first entity is the manager of the database.

26. The method according to claim 1, characterized in that the second database comprises the G-standard, while the patient in step a. and/or the first entity in step e. of claim 8 utilizes the G-standard for filling the first database.

27. The method according to claim 1, characterized in that the information on the identity of the patient is also stored in the first database.

28. The method according to claim 1, characterized in that the information on the identity of the patient also comprises information on the age, the sex, the blood group, the rhesus factor, a general practitioner and/or a pharmacist of the patient.

29. The method according to claim 1, characterized in that the patient prints out, as desired, for a general practitioner or for a pharmacist, a standard letter based on information from the first database on his current use of medications and/or his use of medications in the past.

30. The method according to claim 6, characterized in that the first entity provides access to the patient for him to access the first database via internet, by providing an access code to the patient.

31. The method according to claim 14, characterized in that the patient provides the second entity access to his information in the first database by protecting his information with a password which he gives to the second entity.

32. The method according to claim 31, characterized in that the password concerned provides the second entity access to information of the patient once-only, for a definite period of time or for an indefinite period of time.

33. The method according to claim 31, characterized in that the patient enters at the computer system which information the second entity has access to using the password concerned.

34. The method according to claim 6, characterized in that the computer system, in the carrying out of step c. by the first entity, generates an access code and provides it to the first entity, wherein the intention is that the first entity gives this access code to the patient and wherein the patient can access his data in the first database, preferably via internet, by entering the access code at the computer system, and wherein after the carrying out of step c. by the first entity the first entity is automatically authorized for access of the data of the patient stored and/or yet to be stored in the first database, wherein in consultation with the patient in the carrying out of step c. by the first entity it can be directly entered in the computer system whether the authorization is for a definite period of time or indefinite period of time and what the nature is of the authorization, such as, reading-only, reading and writing, full access or access to a part of the information of the patient and/or characterized in that the initial filling of the database with data of the patient in step c. is carried out by the patient.

35. The method according to claim 34, characterized in that when the patient, for example via internet, accesses the first database, the patient enters at the first database which information of the patient stored in the first database the automatically authorized first entity has access to and/or for how long the first entity has access to information of the patient stored in the first database or that when the patient, for example via internet, accesses the first database, the patient withdraws at the first database the automatic authorization of the first entity.

36. The method according to claim 34, characterized in that the patient has the computer system generate an authorization code for a second entity, such as a physician, hospital, care institution or acquaintance, and gives this authorization code to the second entity.

37. The method according to claim 36, characterized in that the patient also enters at the first database which information of the patient stored in the first database the second entity has access to and/or for how long the second entity has access to information of the patient stored in the first database.

38. The method according to claim 36, characterized in that the second entity, preferably via internet, accesses his/her information stored in respect of the second entity in the first database and with the entry in the computer system of the authorization code which the second entity has obtained from the patient, accesses information of the patient stored in the first database.

39. The method according to claim 34, characterized in that the computer system provides to the patient, preferably via internet, an overview of all entities that have access to data of the patient stored in the first database, possibly to which data which entity has access and possibly for how long which entity has access.

40. A computer system provided with the first database according to claim 1 and the second database according to claim 1, the system being arranged for carrying out a method according to claim 1.

41. A computer system for creating and/or keeping a personal medication file comprising a first database and a second database, the computer system being so arranged that the following step can be carried out:
a. by a patient, information on the use of his personal medication, coupled to information on the identity of the patient, is stored in the first database, characterized in that in the second database of the computer system standard information of known medications is stored, the computer system being arranged to have the patient in step a. utilize the standard information from the second database for filling the first database.

42. The computer system according to claim 41, characterized in that the computer system is arranged for in step a. storing information on the use of a medication by the patient in the first database according to standard information from the second database on the medication to be entered.

43. The computer system according to claim 41, characterized in that the computer system is arranged for, in the entering of the information on the use of the medication by the patient, on the basis of a keyword entered by the patient at the computer system, generating a list of information on possible medications and showing it to the patient, whereupon the patient can choose from the list a medication that corresponds to the medication that he uses, the computer system being arranged to store the selected information on the medication, coupled to the identity of the patient, in the form of standard information in the first database.

44. The computer system according to claim 41 3, characterized in that the computer system is so arranged that the patient, of a medication he uses or has used, can also enter information on the frequency of taking the medication, the form of administration of the medication, the strength of the medication, the use of the medication (for example, the period of taking the medication), the origin of the medication (supplier), the brand of the medication, information on a storage life of the medication, and/or an identity of a person such as a doctor or pharmacist, care institution, pharmacy and/or hospital that has prescribed the medication.

45. The computer system according to claim 41, characterized in that the computer system is arranged so as to generate an alert for the patient when after the entry of new information on a medication used in step a. it appears from the first database that the new information does not go together with information from the first database on the use of a medication that the patient already uses.

46. The computer system according to claim 41, characterized in that the computer system is so arranged that the first database in a step c. can be initially filled with information of the patient by a first entity such as a physician and/or pharmacist and/or pharmacy and/or hospital and/or care institution and wherein the computer system is so arranged that the first entity, for example when the patient indicates he so wishes, can provide the patient access to his information in the first database and/or that the computer system is so arranged that the first database in a step c. can be initially filled with information of the patient by the patient.

47. The computer system according to claim 46, characterized in that the computer system is so arranged that the first database in a step d. can be filled by the first entity and/or by the patient with information on the identity of the patient.

48. The computer system according to claim 46, characterized in that the computer system is so arranged that in a step e. by the first entity and/or by the patient information on the use of the personal medication and/or other information on the patient such as information on tests performed on the patient, for example by the first entity, coupled to information on the identity of the patient, can be stored in the first database.

49. The computer system according to claim 48, characterized in that the computer system is so arranged that in step e. the first entity and/or the patient can utilize the standard information from the second database for filling the first database.

50. The computer system according to claim 49, characterized in that the computer system is so arranged that in step e. information on the use of a medication by the patient can be stored according to standard information from the second database in the first database by the first entity and/or by the patient.

51. The computer system according to claim 49, characterized in that the computer system is so arranged that in step e. in the entering of the information on the use of the medication by the first entity, the computer system, on the basis of a keyword entered by the first entity at the computer system, generates a list of information on possible medications and shows it to the first entity, whereupon the first entity can select from the list a medication that corresponds to the medication that the patient uses, wherein the computer system is so arranged that the selected information on the medication, coupled to the identity of the patient, can be stored in the form of standard information in the first database and/or that the computer system is so arranged that in step e. in the entering of the information on the use of the medication by the patient, the computer system, on the basis of a keyword entered by the patient at the computer system, generates a list of information on possible medications and shows it to the patient, whereupon the patient can select from the list a medication that corresponds to the medication that the patient uses, wherein the computer system is so arranged that the selected information on the medication, coupled to the identity of the patient, can be stored in the form of standard information in the first database.

52. The computer system according to claim 49, characterized in that the computer system is so arranged that the first entity and/or the patient in step e., of a medication that the patient uses or has used, can also enter information on the frequency of taking a medicine of the medication, the form of administration of the medicine, the strength of the medicine, the use of the medicine (for example, the period of taking the medicine), the origin of the medicine (supplier), the brand of the medicine, information on a storage life of the medicine, and/or an identity of a person such as a doctor or pharmacist, care institution, pharmacy and/or hospital that has prescribed the medication.

53. The computer system according to claim 41, characterized in that the computer system is so arranged that the patient can obtain or consult information on his medication from the first database, for example, by downloading, printing or reading from a display.

54. The computer system according to claim 53, characterized in that the computer system is so arranged that the patient can provide access to his information in the first database to a second entity such as a physician and/or pharmacy and/or pharmacist and/or hospital and/or care institution, while, in particular, the patient can also indicate which information the patient provides the second entity access to.

55. The computer system according to claim 54, characterized in that the computer system is so arranged that after the provision of access to the first database by the patient to the second entity, by the computer system information on the patient from the first database can be sent by e-mail or similar message to the second entity and/or that by the computer system the second entity is granted an opportunity to obtain or consult information on the patient from the first database, for example, by downloading, printing or reading from a display.

56. The computer system according to claim 53, characterized in that the computer system is so arranged that the second entity can be provided access to information of the patient stored in the first database only when the patient has provided access to the second entity at the computer system, whereby, for example, the patient can provide the second entity access to information of the patient stored in the first database permanently, for a definite period of time or once-only.

57. The computer system according to claim 56, characterized in that the computer system is so arranged that the second entity in exceptional circumstances, for example, when the patient is in danger of life, can yet obtain access to information of the patient stored in the first database, in which case, however, the fact that the second entity has consulted information on the patient in the first database is stored by the computer system in, for example, the first database so that it can be verified later that the second entity has not taken advantage of the access provided.

58. The computer system according to claim 41, characterized in that the computer system is so arranged that the patient can withdraw the access that he has provided to the second entity again.

59. The computer system according to claim 54, characterized in that the computer system is so arranged that the patient via the computer system can request the first entity, the second entity and/or a third entity such as a physician and/or pharmacy and/or pharmacist and/or hospital and/or care institution to check information on medications from the first database that is coupled to the identity of the patient.

60. The computer system according to claim 59, characterized in that the first database is stored on a first server of the computer system and the second database is stored on a second server of the computer system.

61. The computer system according to claim 60, characterized in that the computer system is so arranged that in step a. the patient; and/or in step c., d., and/or e. the first entity and/or the patient; and/or the second entity can access the first server and/or the second server via internet with the aid of a computer.

62. The computer system according to claim 61, characterized in that the computer system is so arranged that the first entity or the patient; and/or the second entity; and/or the third entity can access the first server and/or the second server via the professional network E-care.

63. The computer system according to claim 62, characterized in that the computer system is so arranged that the first server accesses the second server, for example via internet, for obtaining the standard information on medications, which the patient or the first entity or the second entity utilizes via the first server for entering the medication of the patient in the first database.

64. The computer system according to claim 63, characterized in that the computer system is so arranged that when the patient sends information on his use of a medication, for example on paper or in a memory stick, to a manager of the first database, the manager can enter the medication at the first database, while the patient can first have utilized the second database for obtaining standard information on medication to be entered and/or while the manager can have utilized the second database for entering the medication at the first database with standard information on the medication.

65. The computer system according to claims 64, characterized in that the computer system is so arranged that the first entity can be the manager of the database.

66. The computer system according to claim 65, characterized in that the second database comprises the G standard, while the computer system is so arranged that the patient in step a. and/or the first entity in step e. of claim 48 can utilize the G standard for filling the first database.

67. The computer system according claim 66, characterized in that the computer system is so arranged that the information on the identity of the patient can also be stored in the first database.

68. The computer system according to claim 67, characterized in that the computer system is so arranged that the information on the identity of the patient can also comprise information on the age, the sex, the blood group, the rhesus factor, a general practitioner and/or a pharmacist of the patient.

69. The computer system according to 68, characterized in that the computer system is so arranged that the patient can print out, as desired, for a general practitioner or for a pharmacist, a standard letter based on information from the first database on his current use of medications and/or his use of medications in the past.

70. The computer system according to claim 46, characterized in that the computer system is so arranged that the first entity can provide access to the patient for him to access the first database via internet, by providing an access code to the patient.

71. The computer system according to claim 54, characterized in that the computer system is so arranged that the patient can provide the second entity access to his information in the first database by protecting his information with a password which he gives to the second entity.

72. The computer system according to claim 71, characterized in that the computer system is so arranged that the password concerned can provide the second entity access to information of the patient once-only, for a definite period of time or for an indefinite period of time.

73. The computer system according to claim 72, characterized in that the computer system is so arranged that the patient can enter at the computer system which information the second entity has access to using the password concerned.

74. The computer system according to claim 46, characterized in that the computer system is so arranged that the computer system, in the carrying out of step c. by the first entity, generates an access code and provides it to the first entity, wherein the intention is that the first entity gives this access code to the patient and wherein the computer system is so arranged that the patient can access his data in the first database, preferably via internet, by entering the access code at the computer system, and wherein after the carrying out of step c. by the first entity the first entity is automatically authorized for access of the data of the patient stored and/or yet to be stored in the first database, wherein the computer system is further so arranged that in consultation with the patient in the carrying out of step c. by the first entity it can be directly entered in the computer system whether the automatic authorization is for a definite period of time or indefinite period of time and what the nature is of the automatic authorization, such as reading-only, reading and writing, full access or access to a part of the information of the patient and/or characterized in that the computer system is so arranged that the initial filling of the database with data of the patient in step c. can be carried out by the patient.

75. The computer system according to claim 74, characterized in that the computer system is so arranged that when the patient, for example via internet, accesses the first database, the patient can enter at the first database which information of the patient stored in the first database the automatically authorized first entity has access to and/or for how long the first entity has access to information of the patient stored in the first database and/or that the computer system is so arranged that when the patient, for example via internet, accesses the first database the patient can enter at the first database that the automatic authorization of the first entity is withdrawn.

76. The computer system according to claim 75, characterized in that the computer system is so arranged that the patient can have the computer system generate an authorization code for a second entity, such as a physician, hospital, care institution or acquaintance to give this authorization code to the second entity.

77. The computer system according to claim 76, characterized in that the computer system is so arranged that the patient can also enter at the first database which information of the patient stored in the first database the second entity has access to and/or for how long the second entity has access to information of the patient stored in the first database.

78. The computer system according to claim 77, characterized in that the computer system is so arranged that the second entity, preferably via internet, can access his/her information that is stored in the first database on the second entity and with entry in the computer system of the authorization code which the second entity has obtained from the patient, accesses information of the patient stored in the first database.

79. The computer system according to claim 74, characterized in that the computer system is so arranged that the computer system can provide to the patient, preferably via internet, an overview of all entities that have access to data of the patient stored in the first database, possibly which data which entity has access to and possibly for how long which entity has access.
